(19) United States
(12) Patent Application Publication
(10) Pub. No.: US 2007/0118603 A1
(43) Pub. Date: May 24, 2007

(54) INTERACTIVE MESSAGING SYSTEM

(76) Inventors: Carl Washburn, San Diego, CA (US); Tyler Jensen, San Diego, CA (US); Todd Allen, San Diego, CA (US)

Correspondence Address: KLEIN, O'NEILL & SINGH, LLP, 43 CORPORATE PARK, SUITE 204, IRVINE, CA, 92606, US

(21) Appl. No.: 11/623,001

(22) Filed: Jan. 12, 2007

Related U.S. Application Data
(63) Continuation-in-part of application No. 11/175,765, filed on Jul. 5, 2005.
Application No. 11/175,765 is a continuation-in-part of application No. 11/103,114, filed on Apr. 11, 2005.
Application No. 11/103,114 is a continuation-in-part of application No. 10/395,187, filed on Mar. 21, 2003.

(51) Int. Cl. G06F 15/16

(52) U.S. Cl. 709/206

(57) ABSTRACT

The interactive messaging system of the present invention provides for an interactive communication process between users, both senders and recipients. The sender composes a message by filling in a template stored in data services. Once completed, the sender pushes the message to a recipient's wireless device if the wireless device contains a WAP browser, which is capable of receiving pushed messages. Typically the message includes a question along with answers for the recipient to choose from. Each answer corresponds with a pre-assigned response key and the recipient answers the question by selecting one of the pre-assigned response keys. The recipient's response is available to the sender in the form of an e-mail, WAP Push, on-line access or interactive message that is shown to the sender on an on-line status screen.

This application is a continuation-in-part application of United States non-provisional application Ser. No. 11/175,765 filed Jul. 5, 2005, which is a continuation-in-part application of United States non-provisional application Ser. No. 11/103,114 filed Apr. 11, 2005, which is a continuation-in-part application of United States non-provisional application Ser. No. 10/395,187 filed Mar. 21, 2003.

### FIELD OF THE INVENTION

The present invention relates generally to the field of text messaging More particularly, the present invention relates to an interactive messaging system.

### BACKGROUND OF THE INVENTION

Today, wireless or mobile devices are becoming more common as wireless carriers build out their networks, rates decrease and device technology increases. Users of the wireless devices have been able to send a message to a wireless device using Short Message Service (SMS) messaging. SMS messaging was introduced in the first phase of GSM during 1991 as a simple store-and-forward text message system. Using SMS messaging, a user can use a computer or a wireless phone to compose a text message and send it to a wireless device. SMS messaging has enjoyed steady growth and it is estimated that a total of 360 billion messages were sent in the year 2002.

Despite the popularity of text messaging, SMS messaging growth in the United States has been somewhat slower compared to growth in Europe. The difference in growth can be attributed to the technology limitations of SMS messaging on wireless devices. Users composing a text message, or a reply, on a mobile device must use a somewhat awkward Man Machine Interface (MMI) which requires users to press multiple keys or buttons (multi-tapping) on the wireless device for each letter. For example, to type the letter “s”, a user needs to press the number 7 key on the device 4 times (i.e. PQRS).

Text on nine keys (T9®) was then developed as a faster alternative to multi-tapping. It enables users to type letters with a single key tap per letter and then uses predictive software to guess the word the user intended to type. However, many users find predictive text entry somewhat frustrating when the software guesses the incorrect word and still tedious as each letter still requires a single key tap. Furthermore, both the SMS messaging and T9® required numerous presses of keys or buttons. The user may be required to press keys or buttons over 100 times with SMS messaging and over 300 times using T9®.

Another technology that enables the delivery of data to wireless devices is Wireless Application Protocol (WAP). WAP is a global specification and open standard that enables wireless device users to interact and access services and information. WAP is both a communications protocol and application environment that can be built on numerous operating systems and provides interoperability between different device families. WAP is used by a variety of devices including mobile phones, mobile pagers, two-way radios, smartphones and communicators. WAP is designed to work with multiple wireless networks such as CDPD, CDMA, GSM, PDC, PHS, TDMA, FLEX, ReFLEX, iDEN, TETRA, DECT, DataTAC, Mobitex and GPRS.

One of the recent technology advances with WAP is the development of the WAP Push. A push can be a WAP browser session that appears on the screen of a mobile device without an explicit request from the user at the time the session is initiated. In the normal client/server model, a client requests a service or information from a server, which responds by providing the information to the client. This is known as “pull” technology, i.e. the client pulls the information from the server. An example of pull technology is the Internet, a user enters a URL which is sent to a server and the server responds by sending a web page to the user. Although WAP Push is also based on the client/server model, it provides the means to initiate a WAP application session on the user's device without an explicit request from the user.

With WAP Push, a user can receive a pushed message and can immediately respond to the message by pressing a key. For example, a user can subscribe to a service, which will cause a pushed message to be sent to the user's wireless device for predetermined events and times. At predetermined times during the day, a stock quote can be pushed to the user's wireless device giving the user the option to purchase stock by selecting a buy button. WAP Push, however, does not provide for a sender composing an interactive message by filling in a template with a question with a recipient responding by selecting at least one answer corresponding to a pre-assigned response key. Furthermore, WAP Push does not provide for brokering an event among multiple parties.

### SUMMARY OF THE INVENTION

It is an object of the present invention to compose an interactive message by filling in a template and pushing the interactive message to a wireless device user.

It is another object of the present invention to package complex data and messages into a format for wireless devices wherein the user can easily respond by selecting at least one pre-assigned response key.

It is yet another object of the present invention for an application server to manage an interactive workflow and collaboration between users, including both a sender and a recipient.

It is yet another object of the present invention to send data and messages to multiple users and summarize the responses received from all users.

It is yet another object of the present invention to maintain profile settings for each user; the settings include filtering, blocking, prioritization and level of intrusion.

It is yet another object of the present invention to provide a web services framework allowing third party applications to access the application framework.

In the present invention, an application framework is used to integrate data systems to wireless devices. A web services platform, located on the application framework, shares business logic, data and process through a programmatic interface across a network amongst core services. Core services are comprised of data services, messaging services, brokering services and learning services. The core services are utilized by users to send interactive messages to other users.

The interactive messaging system of the present invention provides for an interactive communication process between users, both senders and recipients. The sender composes a message by filling in a template stored in data services. Once completed, the sender pushes the message to a recipient's wireless device if the wireless device contains a WAP browser which is capable of receiving pushed messages. Typically the message includes a question along with answers for the recipient to choose from. Each answer corresponds with a pre-assigned response key and the recipient answers the question by selecting one of the pre-assigned response keys. The recipient's response is available to the sender in the form of an e-mail, WAP Push, on-line access or interactive message that is shown to the sender on an on-line status screen.

The interactive messaging system of the present invention can be utilized in many ways including to propose a question to a recipient and receive the recipient's response, to broker an event such as a call, a conference call a game, etc., as an interactive learning tool, as an interactive reminder and to receive approval for a specified event or purchasing of an item.

The foregoing, together with other features and advantages of the present invention, will become more apparent when referring to the following specification, claims and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1a illustrates an application framework showing core services;

FIG. 1b illustrates a web application server sending information to a mobile access gateway utilizing BREW® technology;

FIG. 2 illustrates is a top level diagram of an exemplary network architecture that is typical of the type with which the system and method of the present invention may be implemented;

FIG. 3a illustrates a method of pushing an interactive message to a wireless device;

FIG. 3b illustrates an example of an interactive based system of the present invention utilizing electronic authentication;

FIG. 4 illustrates a user registration and profile form of the present invention;

FIG. 5a illustrates an example of utilizing the interactive messaging system of the present invention to sign up users for the ability to purchase wallpaper for downloading to a wireless device;

FIG. 5b illustrates an example of utilizing the interactive messaging system of the present invention to notify users of available wallpaper for downloading to a wireless device;

FIGS. 6a-6f illustrate an example of utilizing the interactive messaging system of the present invention to allow carriers to access a mobile alerts dashboard;

FIGS. 7a-7i illustrate mobile alerts dashboard admin screens the dashboard user can access;

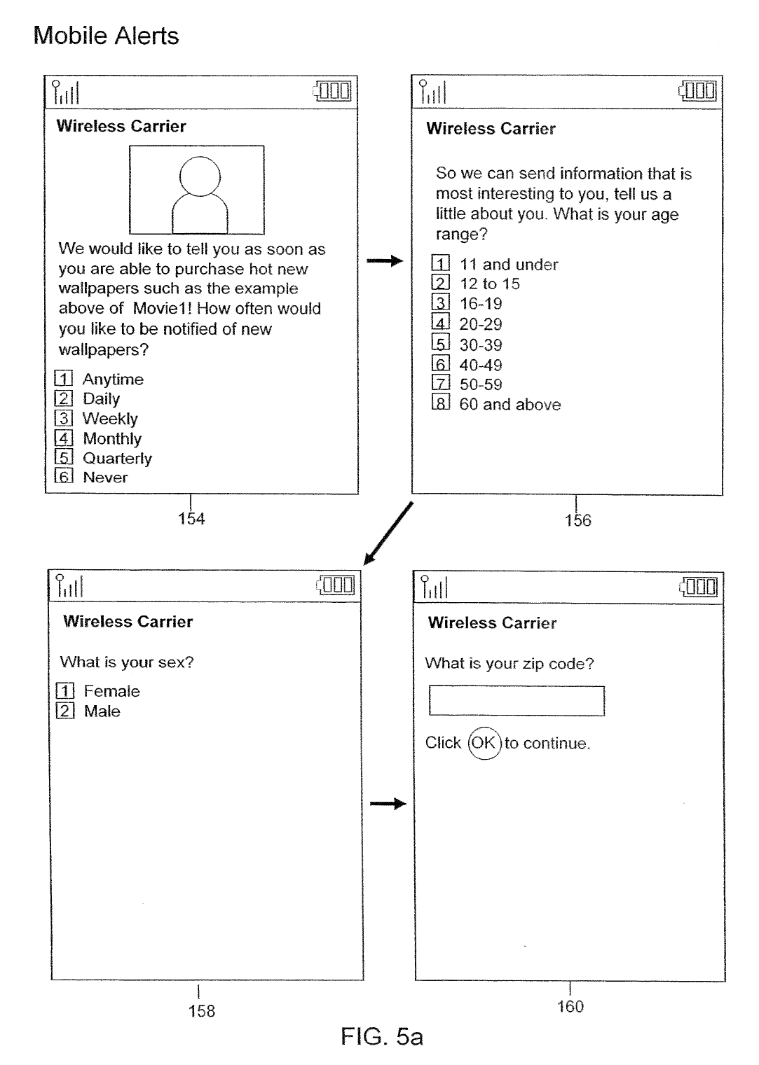

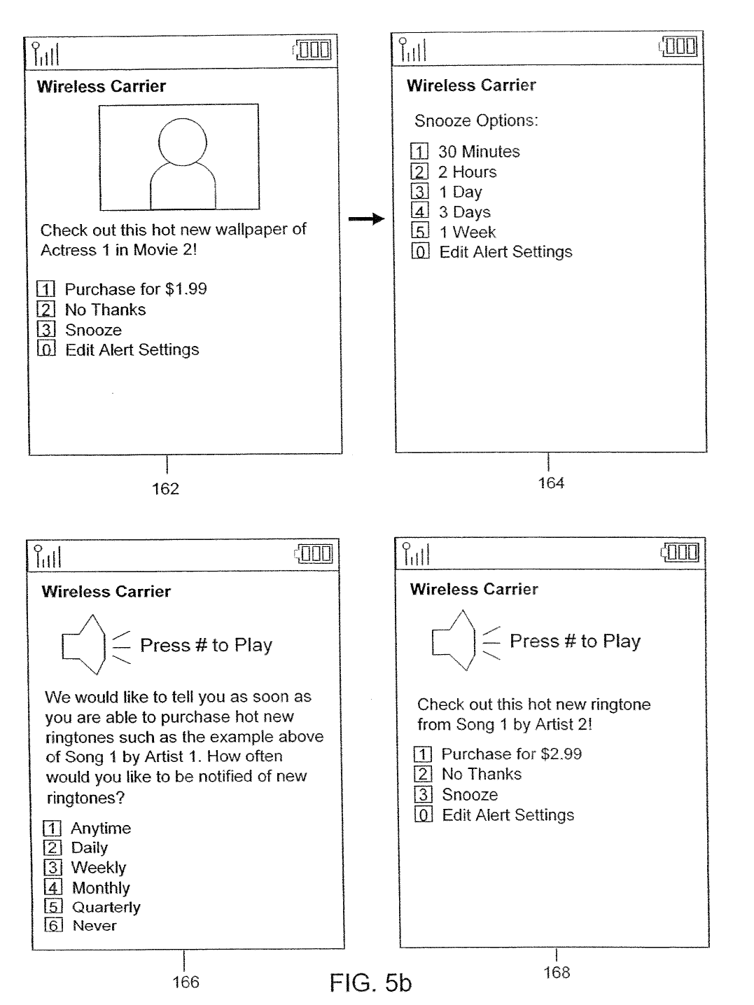

FIGS. 5a-8e illustrate mobile alerts dashboard ringtones screens the dashboard user can access;

FIGS. 9a-9e illustrate mobile alerts dashboard wallpaper screens the dashboard user can access;

FIGS. 10a-10e illustrate mobile alerts dashboard application screens the dashboard user can access;

FIGS. 11a-11e illustrate mobile alerts dashboard hardware screens the dashboard user can access;

FIGS. 12a-12c illustrate mobile alerts dashboard surveys screens the dashboard user can access;

FIGS. 13a-13b illustrates mobile alerts dashboard opt-in subscribers screens the dashboard user can access;

FIGS. 14a-14b illustrates mobile alerts dashboard 3^{rd} party surveys screens the dashboard user can access;

FIG. 15a illustrates a method of sending offers and coupons to a user's mobile wireless device; and

FIG. 15b illustrates a method of viewing saved offers and coupons on a user's mobile wireless device.

### DETAILED DESCRIPTION OF THE DRAWINGS

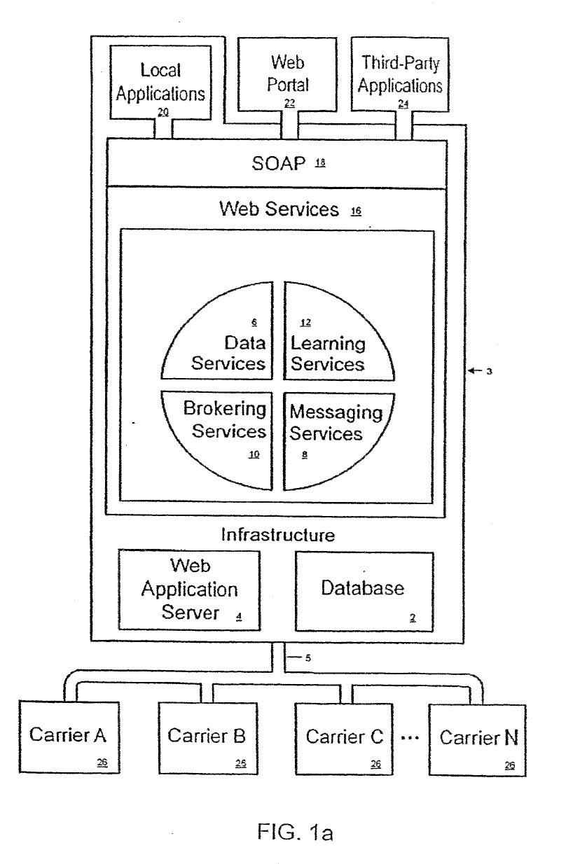

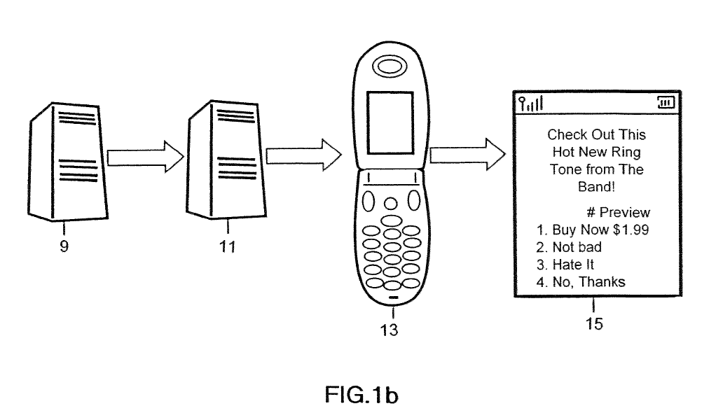

FIG. 1a illustrates an application framework 3 of the present invention for allowing communication with wireless device users, both senders and recipients, by sending or pushing interactive messages to the wireless devices. Messages are composed by filling in a pre-formed template and the application framework 3 pushes the messages to carriers A-N 26, which are connected to the framework 3 via a network connection 5, the messages are then sent to wireless devices. Although four carriers are shown, additional carriers may connect to the framework 3. A messaging protocol on the application framework 3 allows both local applications and outside or third party applications to talk to core services. Core services, located on the application framework, facilitate the delivery of messages by providing essential details and information that the framework uses to send or push the messages to wireless devices. In the preferred embodiment, the core services are comprised of data services 6, messaging services 8, brokering services 10 and learning services 12, although additional services may be defined and utilized. The core services are exposed via web services 16.

The learning services 12 are used to facilitate learning by sending or pushing study material, such as in the form of multiple-choice questions, to recipients, such as students and is the subject of U.S. patent application 2004/0186889 entitled, “Interactive Messaging system”, Ser. No. 10/395,187, filed on Mar. 21, 2003, all of which is assigned to the assignee of the present application, and the disclosure of which is incorporated herein by reference in its entirety.

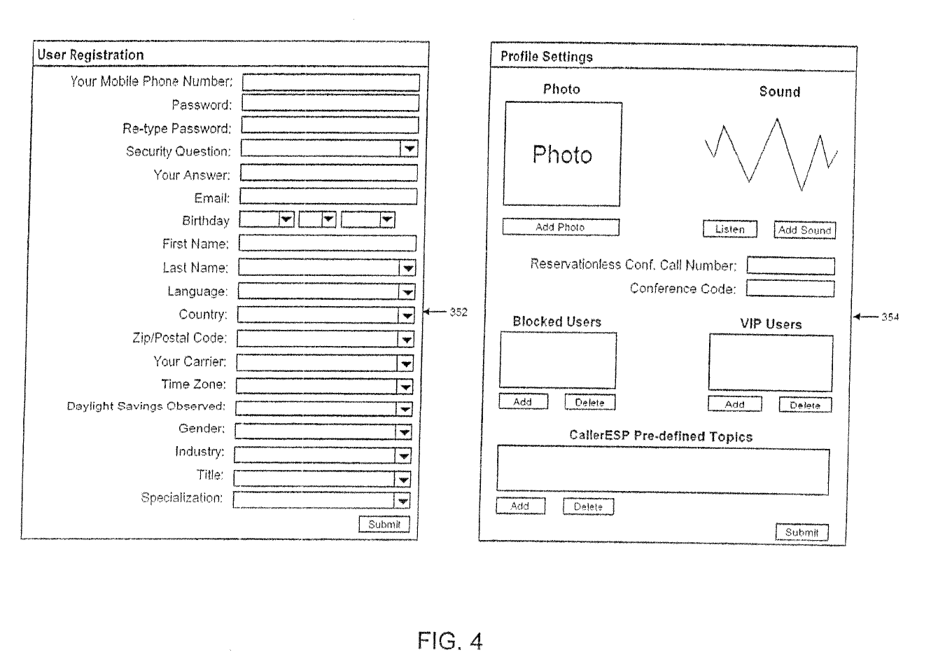

The data services 6 stores information, including profiles of the users, which determine if and when the interactive message is to be sent to the recipient. Information stored within the profiles can include an access control list that filters or blocks specific senders, photographs and sounds which may be included in the message and a do not disturb window specifying when the recipient does not want to be disturbed with an interactive message. Additional information in the profiles can include a priority profile where the user can specify the level of intrusion for receiving the interactive message by the sender (i.e. do not interrupt if on a call) and also stores ID and password information, frequently used response lists to be included in the message, a list of birthdays and anniversaries of friends and family and other holidays. Other information, such as pending messages and system information is stored in data services 6. Each user creates his profile (described below with reference to FIG. 4) and stores the profile on a database 2 located on the application framework 3. Other information contained in the profiles includes a list of people whose messages should be immediately sent, a picture of the user, times when a user does not want to receive a message, and the user's preferences in purchasing goods and services such as a favorite music genre. These profiles can be accessed through a web portal 22 allowing senders and recipients to update their profile.

The messaging services 8 push the interactive message to the wireless device of a recipient. Before the message can be pushed, messaging services 8 first determines if the recipient's wireless device is capable of receiving a pushed message. If the wireless device is capable of receiving the message, messaging services 8 converts the message into a format readable by the wireless device and in turn pushes the message to the wireless device. If the wireless device is not capable of receiving a pushed message, message services 8 converts the message to a short message service (SMS) message and sends as a SMS message. Furthermore, messaging services 8, if necessary, is capable of formatting the message into a format that includes multimedia capabilities such as text, sound, graphics, W.L., MIME, video or a turn based interactive game. Messaging services 8 also has the capability of providing the sender with a status of the message, i.e. if the recipient has responded and what the response is. The status of the message can be delivered to the sender with electronic data exchange, e-mail, instant messaging, on-line access (i.e. check the status via a web site) and WAP Push, including BREW® and J2ME (JAVA). The sender can set the form that the status of delivery is sent in his profile or when filling out the template to send the message.

The brokering services 10 manage the coordination of users, both senders and recipients, and the delivery of messages to wireless devices. Senders call specify a day and time for the messages to be delivered to the recipients. (Senders can include both people and devices/servers.) Recipients have the option of re-scheduling the response of messages to their wireless devices by selecting a “snooze” feature. The “snooze” feature terminates the interactive message and schedules a future time when the message will be resent to the recipient. Once this feature is selected, the brokering services 10 will resend the message at a later time such as in 10 minutes, 30 minutes, an hour or any other time specified by the recipient. Brokering services 10 also manages the level of intrusion of the message based on receiver-maintained profile criteria via the web portal 22 with settings by originator, data type, priority and access control list. The status of all invitees is shown to all participants.

The application framework 3 utilizes application logic to define how the business policies, rules and required services of the interactive messaging system of the present invention function. Local applications 20 store the application logic and call web services 16 using SOAP messaging 18 and instruct or trigger the construction and delivery of the interactive messages. Web services 16 shares business logic, data and process through a programmatic interface across a network amongst the core services. Since web services 16 are not tied to any one operating system or programming language, different applications from different sources communicate with each other without time consuming custom coding since all communication is in XML. As a result, web services 16 provides a platform for exposing or making accessible the core services to third party applications 24 using software that is running on different operating systems and devices, written using different programming languages and tools from multiple vendors, all potentially developed and deployed independently. As a result, an open architecture for third parties is created. Furthermore, web services 16 enables the interactive messaging system of the present invention to be used with or without a browser.

Also located on the framework 3 is a web application server 4. The web application server 4 is comprised of software that runs on the framework 3, answers web calls from (1) a wireless device (2) via web portal 22 and (3) third party 24 and local applications 20. When answering a call, web services 16 looks up the requested information in a database 2, databases such as Oracle® may be utilized. The database 2 is used to store data, information and rules for pushing the interactive messages to a wireless device. Specifically, stored within the database are user preferences, photographs, sounds, drop down menus, and any other information concerning users. Upon receiving a call, the web application server 4 retrieves the information in the database 2 via data services 6.

The application framework 3 discussed with reference to FIG. 1a enables users to send various types of interactive messages. The various types of messages include, but are not limited to, scheduling a meeting, sending a reminder, sending an offer and sending an invitation. These and other embodiments are discussed below.

In addition to utilizing WAP push technology, the present invention can also utilize application-directed SMS messaging within BREW® or JAVA technologies. BREW® and JAVA are other technologies analogous to WAP push allowing non-solicited messages to be sent to users. BREW®and JAVA wake-up using SMS provides the same ability to push messages to users, as does WAP push. In WAP push, a SMS message containing a URL address is sent to the user. Upon receiving the SMS message, the device loads the web page, which contains interactive response messages. With BREW® and JAVA, an application is pre-loaded on a wireless device. An application directed SMS message “wakes up” the application on the phone providing interactive response options. FIG. 1b illustrates web application server 9 sending information to a mobile access gateway 11, which sends the information to a wireless device 13, which displays the information on a display screen of the wireless device 13. Although FIG. 1b illustrates a question from the learning curriculum being displayed, this is by way of example only and any information can be pushed to the wireless device.

Although the display screen 15 illustrates information to purchase a ring tone, this is by way of example only and any information can be pushed to the wireless device. The mobile access gateway is a server in the carrier's network that allows messages to be transformed into a WAP Push over the carrier's network to the recipient's wireless device 13.

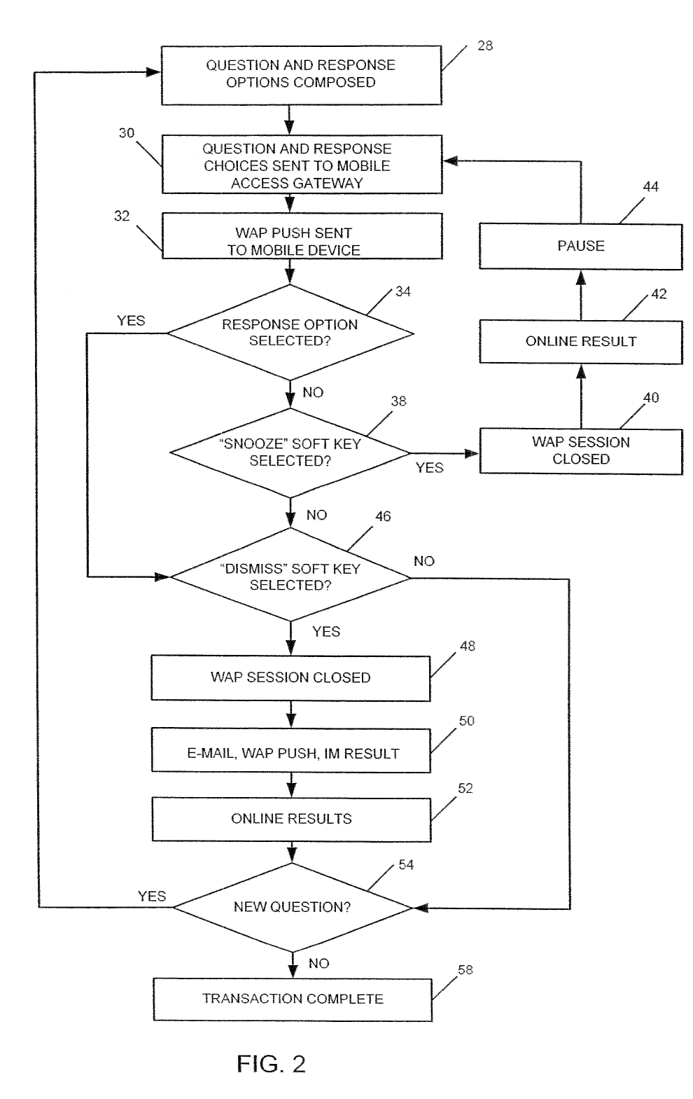

FIG. 2 illustrates a flow diagram of a method of the present invention for pushing interactive messages to a wireless device. In preparing and pushing an interactive message to a recipient's wireless device, a sender composes questions and responses on a pre-formed template 28. The template, located in the data services 6 of the framework 3, is typically accessed by the sender by using a computer connected to the Internet. Once the message has been composed, the interactive message is sent to a mobile access gateway 30. Upon receiving the interactive message, the mobile access gateway pushes the interactive message to the recipient's wireless device 32. The recipient's wireless device receives the interactive message and a browser session is started by a session initiation application (SIA). The SIA displays a screen with the question and response options composed by the sender.

Once the question and responses appear on the screen of the recipient's wireless device, the recipient may select a response corresponding to a pre-assigned response key 34. If the pre-assigned response key is not selected, the recipient has the option of selecting a snooze message key 38. If the snooze message key 38 is selected, the interactive messaging system 40 is closed and a pre-defined delay occurs before the interactive message is again pushed to the recipient's wireless device. The status of the recipient's response, i.e. selecting the snooze key, is shown to the sender on an on-line status screen 42 or any other method, Such as e-mail defined in the template. The interactive message is then paused for the length of time specified by the snooze key 44. After this specified time period is over, the question and responses are resent by the mobile access gateway and steps 30, 32 and 34 are repeated.

If the pre-assigned response key is not selected and the snooze message key is not selected, the recipient has the option of selecting a pre-assigned response key corresponding to a dismiss feature 46. By dismissing the interactive message, the interactive messaging session is closed 48. The result or status of this session, i.e. the session is closed, is sent back to the sender in the form of an e-mail, WAP Push, on-line access or interactive message 50 that is shown to the sender or an on-line status screen 52. The sender can choose to push a new message to the recipient 54 and in which case the process begins again with the sender composing questions and response options 28. If the sender chooses not to push a new message to the recipient the transaction has been completed and the interactive messaging session is closed 58.

If the pre-assigned response key is selected, the recipient has the option of selecting a pre-assigned response key corresponding to a dismiss feature 46. If the dismiss key is selected, steps 48, 50, 52 and 54 are repeated. If the dismiss key is not selected 46, then the sender may compose a new message with a new question and response choices that are sent to the recipient to clarify or follow-up on the response 54. If the sender chooses to push a new message to the recipient, the whole process is repeated starting with step 28. If the sender chooses not to push a new message to the recipient the transaction has been completed and the interactive messaging session is closed 58.

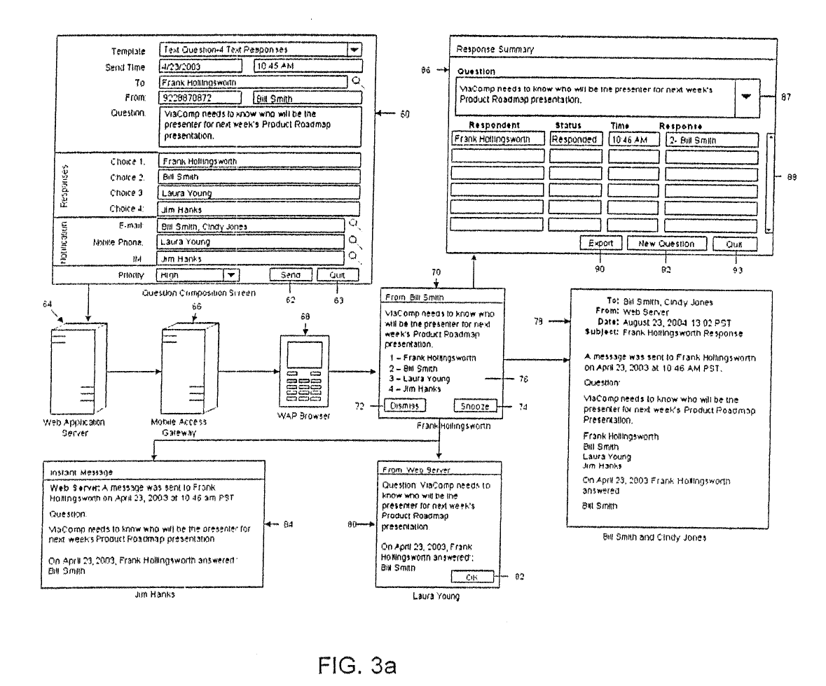

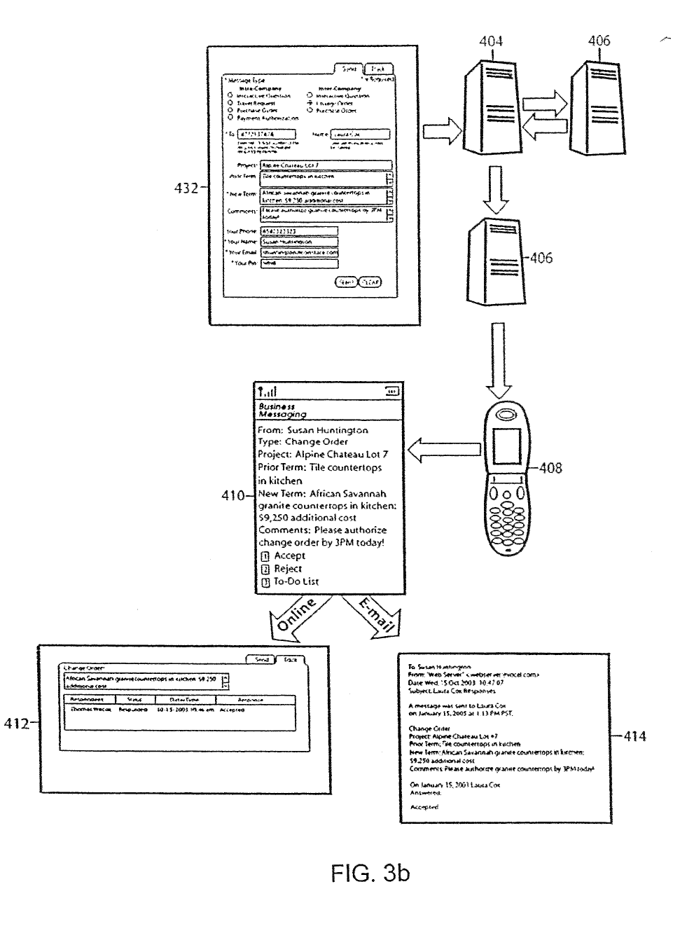

FIG. 3a illustrates a method of pushing an interactive message to the wireless device of a recipient. A template 60 is utilized by a sender to compose the interactive message, including the question and responses, which will be pushed to a recipient's wireless device. A computer connected to the Internet or a wireless device can be used to access the template. Several fields are included on the template, including drop down menus from which the sender can select from a variety of elements to be included in the message. Elements can include, but are not limited to, the type of template and the priority of the message to be sent. Other fields to be filled in by the sender can include the recipient of the message, the sender of the message, the question included in the message, several responses corresponding to pre-assigned response keys for the recipient to choose from, the method of notification of the response to selected individuals and the priority of the message. In the preferred embodiment, a send time default is immediate, however, a sender can schedule to have the message sent at a specific data and time in the future.

Templates can vary, such as requiring a varying amount of response options to be entered (i.e. four response options, six response options, etc.) as well as the type of data used for the question and response options. The question and response options can be a graphic image; a sound, animation, WML, MIME, a video clip or a turn based interactive game. The priority option allows the sender to indicate the priority and specify the level of intrusiveness for the message to be delivered. For example, do not interrupt the recipient if he is on the phone.

If the sender chooses to cancel the interactive messaging session prior to sending the message, the sender selects a quit button 63 located on the template 60. However, if the sender chooses to send the message, the sender selects a send button 62 located on the template 60 after the template 60 has been filled in. After selecting the send button 62, the interactive message is sent to a web application server 64 which immediately sends the message to a mobile access gateway 66 or holds the message to be sent in the future time and date specified by the sender in the template. The mobile access gateway 66 is a server in the carrier's network that allows messages to be transformed into a WAP Push over the carrier's network to the recipient's wireless device, if the recipient's wireless device contains a WAP browser 68. If the recipient's wireless device does not contain a WAP browser 68 or the WAP browser 68 does not have the capability of receiving pushed messages, the message is sent to the wireless device in the form of a SMS message.

Once the message is pushed to the recipient's wireless device, a browser session is started by the Session Initiation Application (SIA), which displays a screen 70 with the question and response options corresponding to pre-assigned response keys. The sender has the option of selecting one of the pre-assigned response keys in response to the question, selecting the dismiss button 72 or selecting the snooze button 74. If the recipient selects one of the pre-assigned response keys 76, the interactive messaging session is completed and the browser session is closed. Selecting the dismiss button 72 cancels the interactive messaging session and selecting the snooze button 74 temporarily terminates the interactive message and schedules the message to be resent at a later time.

Once the recipient has selected a response, notification of the response selected is sent via e-mail, WAP Push, instant messaging or on-line access as specified in the template 60. The notification can show the question, the response options, the response selected and the date the selection was made. As specified in the template 60, notification of the selected response can be sent to at least one third party in addition to the sender of the message. As shown in FIG. 3a, third party notification can be automatically sent in the form of an e-mail 78, a message pushed to a wireless device 80 or an instant message 84 as specified in the template. When the notification is pushed to a wireless device 80, the interactive messaging system can be cancelled by selecting an OK button 82. The sender can also receive the recipient's response by accessing the status of the message on-line 86. On-line notification or status illustrates the question sent by the sender; a drop down box 87 allows the sender to select previous questions sent as well as the responses received. The on-line status 86 also illustrates a summarization table 88 showing status, time and response by user. This table is useful in summarizing results from multiple respondents. All export button 90 can be selected for exporting into a comma delimited text file so that it can be imported into a spreadsheet for further analysis. Selecting a new question button 92 allows the sender to access the original template to compose or edit a new question to follow up or clarify the question based on the recipient's response.

In FIG. 3a, a sender, Bill Smith, composes a message to Frank Hollingsworth by filling in a template with a question, four possible responses and the names of those to receive the response. The question, who will be the presenter for a presentation, is pushed to Frank along with the foul possible answers to the question Upon receiving this message, Frank selects the presenter by selecting a pre-assigned response key corresponding to the name of the presenter. Once selected, a status is sent to all people identified in the template to receive the response. The interactive message of the present invention can also be used to confirm appointments, such as a doctor's appointment, a dentist appointment, a hair appointment, etc. Furthermore, a message can be pushed to a recipient asking if the recipient can still make the appointment. The recipient responds to the question by either selecting a “yes” key or a “no” key. If the recipient is unable to make the appointment that time can be allocated to another person. Interactive messaging can also be used for opinion surveys and by schools to send information to parents about their children.

FIG. 3b illustrates an example of an interactive template based system of the present invention utilizing the electronic authentication. First, a user or sender selects one of many pre-defined templates to send a message to a recipient. III the example illustrated in FIG. 3b, a template 432 designed for a company for sending a message to a recipient is illustrated. The sender fills in the template 432 by selecting the message type, enters the name and telephone number of the recipient, the name of the project, the prior terms of the project, the new terms of the project to be approved by the recipient, any comments the sender has and the name, telephone number and email of the sender. Once this information has been entered into the template, the sender selects a send button (or the clear button to clear the template) and the message is sent to a web application server 404 that sends the message to an authentication server 406 and assigns a date and time stamp to the message. To provide additional security, non-repudiation and authentication to the template-based secure messaging architecture of the present invention, a postmark such, as the United States Postal Service Electronic Postmark (USPS® EPM) can be utilized. The electronic authentication is a Web based security service that enables users to verify authenticity, provide tamper detection and date and time stamp to electronic messages. Evidence of content authenticity can be stored in a repository to ensure trusted non-repudiation of content. Additionally, the electronic authentication provides a tracking number whereby all parties involved in an electronic transaction can access the transaction record on the authentication server and verify the electronic signature, time stamp and content. The electronic authentication enables transactions to comply with the ESIGN legislation, enacted in June 2000, which made electronic signatures a legally viable option for conducting business.

After a date and time stamp has been assigned to the message, the message is sent back to the Web application server 404, which then immediately sends the message to a mobile access gateway 406. The mobile access gateway 406 is a server in the carrier's network that allows messages to be transformed into a WAP Push, including BREW® and JAVA, over the carrier's network to the recipient's wireless device 408.

Once the message is pushed to the recipient's wireless device, a user session is started which displays a screen 410 with information provided by the sender and response options corresponding to pre-assigned response keys. In the example illustrated in FIG. 3b, the pre-assigned response keys are (1) accept, (2) reject, or (3) to-do list. Selecting the accept key authorizes the change order, selecting the reject key rejects the change order and selecting the to-do list which places the request on hold until the recipient makes a decision. Once the recipient has selected a pre-assigned response key, notification of the response selected is sent to the sender on-line 412 or via email 414.

To participate in an interactive messaging session, each user must fill out a registration form and profile settings. FIG. 4 illustrates an example of a user registration form 352 and profile settings 354. In the user registration, the user can enter information such as their wireless phone number, password, security question, answer to security question, email address, birthday, name, address, wireless phone carrier, etc. In the profile settings, the user can add a photo of themselves, sounds, conference call number, conference code, a list of blocked users, a list of VIP users, etc.

The interactive messaging system of the present invention can be utilized for, including but not limited to, enrolling users to purchase items, recommending items for users to purchase and information users of offers or opportunities to purchase items. FIG. 5a illustrates an example of utilizing the interactive messaging system of the present invention to sign up or enroll users for the ability to purchase wallpaper for downloading to a wireless device. Upon the user indicating that the user would like to be notified of purchasing newly available wallpaper for wireless devices, a screen is pushed to the user's wireless device asking how often the user would like to be notified of new wallpaper 154. After selecting a time frame, such as anytime, daily, weekly, quarterly and never; additional screens are pushed to the user's wireless device asking what the user's age range is 156, what sex the user is 158, and the zip code the user lives in 160. This information is utilized by the wireless carrier selling the wallpaper to identify wallpaper that the user will be most likely interested in. For example, if the user is 11 and under, the user would more likely be interested in cartoons while a user who is a male and over 20 would most likely be more interested wallpaper of action movies. Although FIG. 5a illustrates an example of purchasing wallpaper, this is by way of example only and any product can be purchased using the method of the present invention.

As shown in FIG. 5b, after being set up in the system, messages are pushed to the user when new wallpaper is available that user might be interested in based on the information the user provided to the wireless carrier 162. The user can choose to purchase the wallpaper, not purchase the wallpaper, request to be reminded later by selecting a snooze button or edit the alert settings. If the user chooses the snooze option, a message is pushed to the user's wireless device asking the user to select when the alert or message should be reset or if the user wants to edit the alert settings 164. Upon selecting edit alert settings from either message, the user can change when messages or alerts are pushed to the user's phone. FIG. 5b also illustrates an example of utilizing the interactive messaging system of the present invention to sign up users for the ability to purchase ringtones for downloading to a wireless device. Upon the user indicating that the user would like to be notified of newly available ringtones for purchase for wireless devices, a screen is pushed to the user's wireless device asking how often the user would like to be notified of new ringtones 166. The user then selects a time frame, such as anytime, daily, weekly, monthly, quarterly and never. After being set up in the system messages are pushed to the user when new ringtones are available 168. The user can choose to listen to the ringtone or song by pressing the # button, purchase the ringtone or song, not purchase the ringtone or song, request to be reminded later by selecting a snooze button or edit the alert settings.

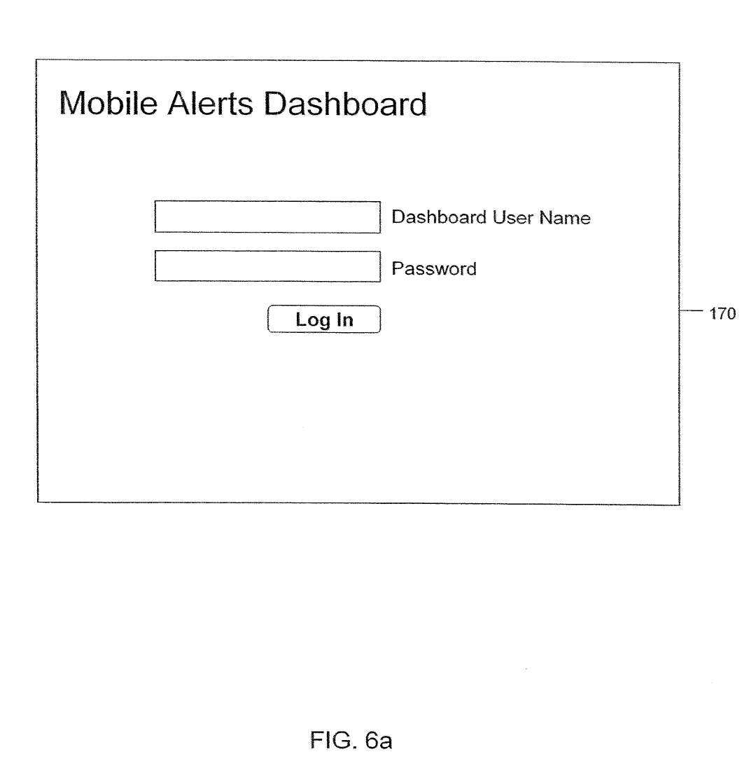

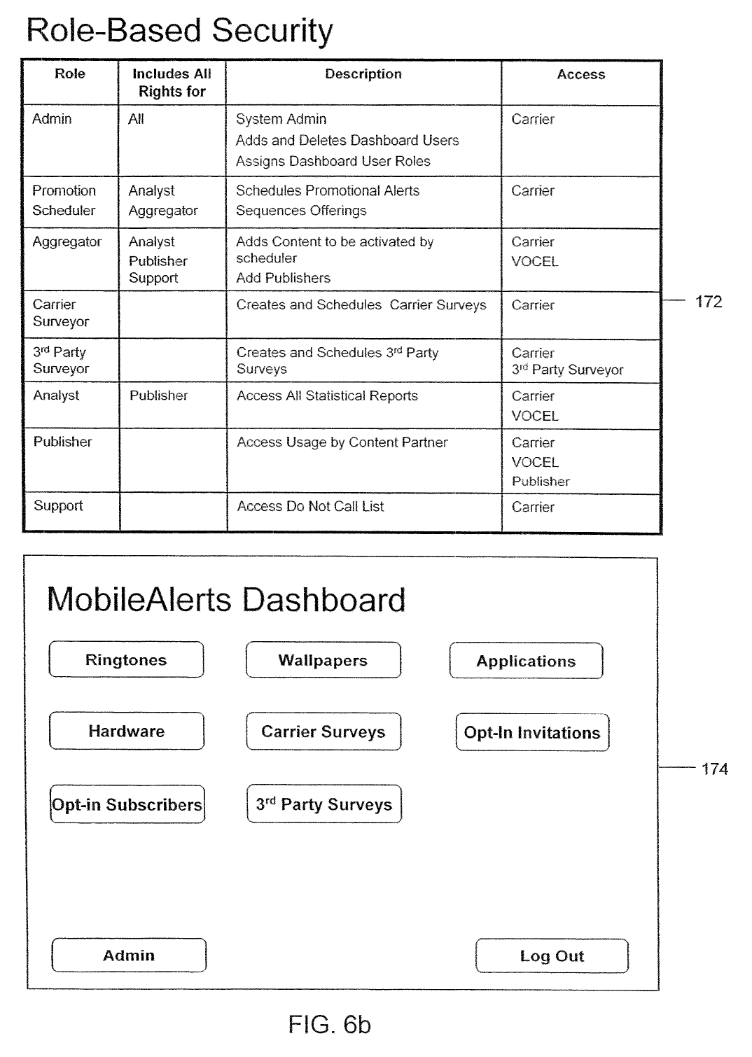

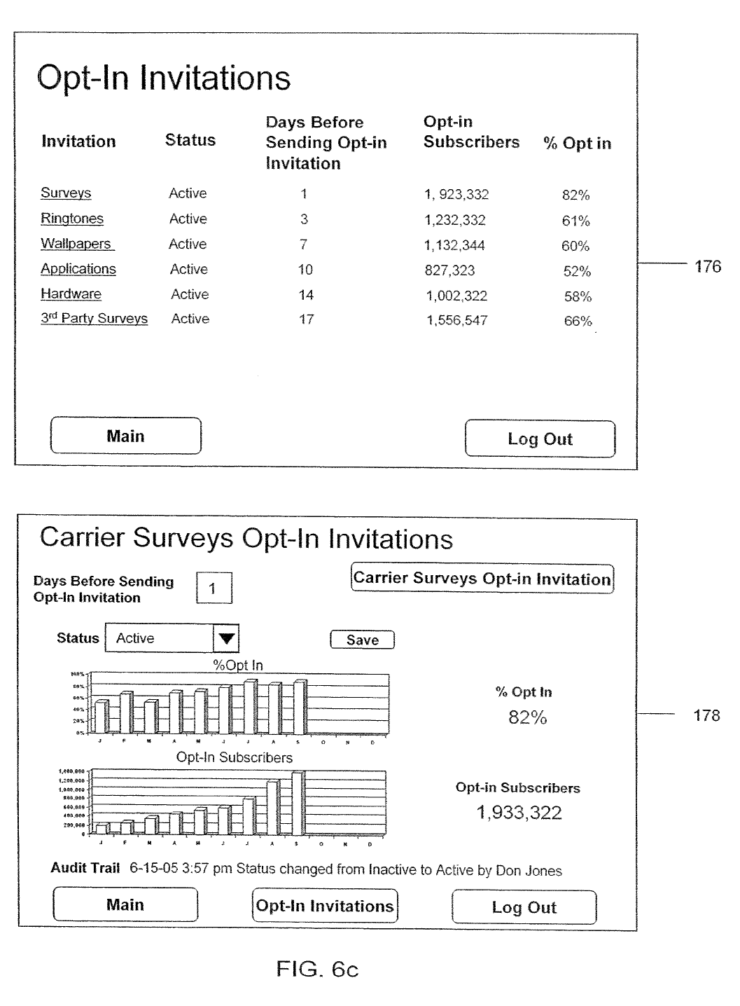

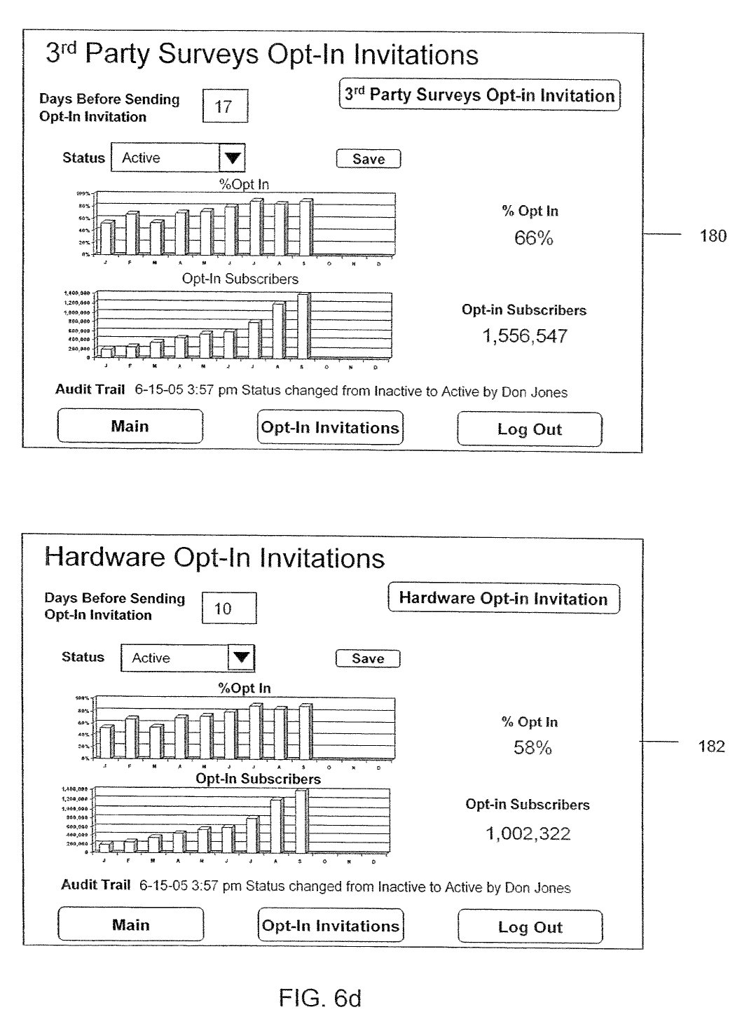

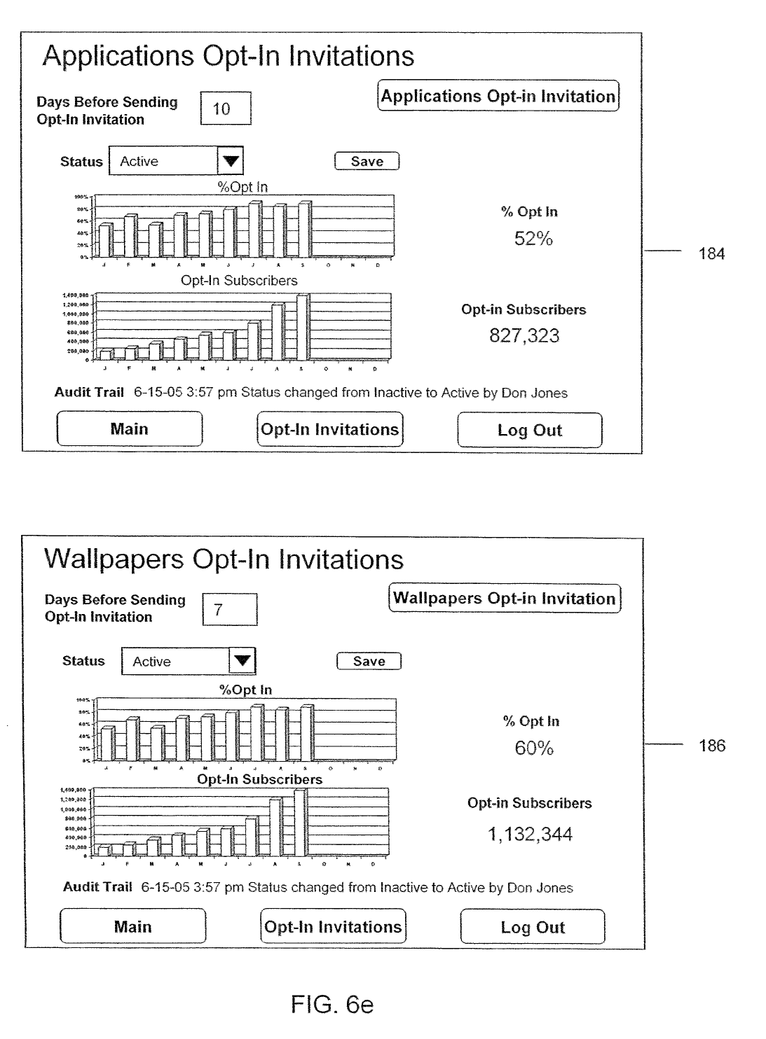

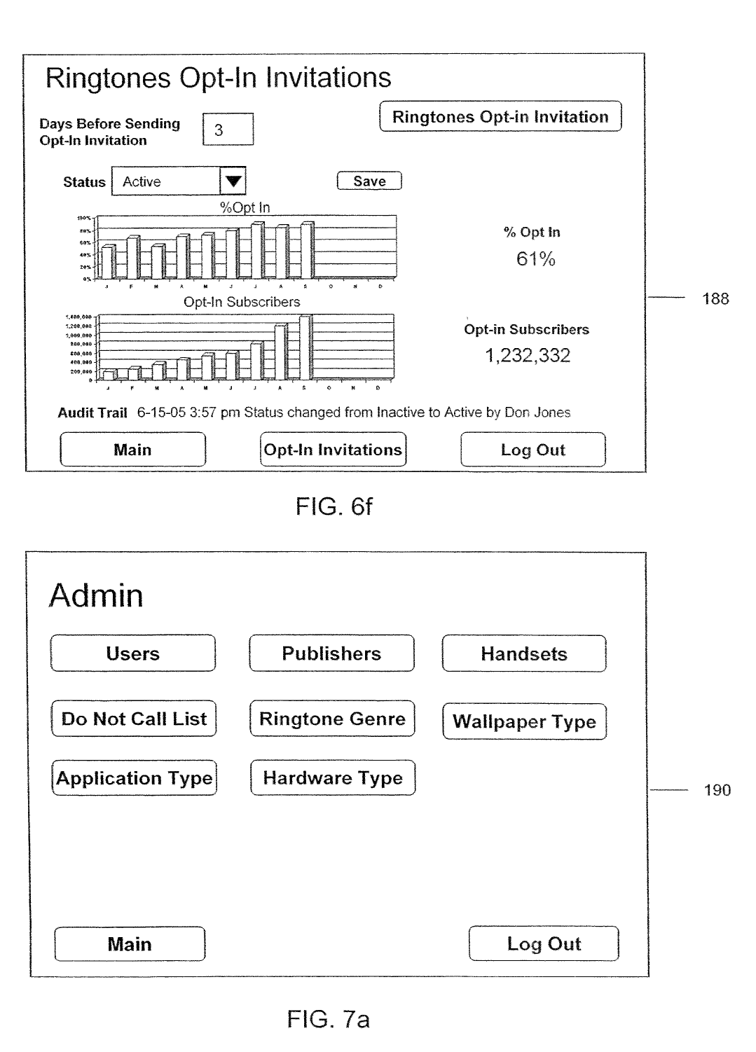

FIG. 6a illustrates an example of utilizing the interactive messaging system of the present invention to allow carriers, providers or publishers to access a mobile alerts dashboard. The mobile alerts dashboard allows the dashboard user to view various statistics about purchases from users, to view survey results, to alter what can be purchased by adding or removing products and to alter the survey by adding or removing questions. To access the mobile alerts dashboard, the dashboard user must enter a dashboard user name and a password 170. This screen is accessed via the Internet. Upon accessing the dashboard, the dashboard user is provided with a table illustrating the role-based security of the system 172. See FIG. 6b. The table identifies the security role, such as the administrator, the promotion scheduler, the aggregator, the surveyor, etc., the rights that are included with the security role, the description of the services provided by the security role and who has access to this role.

FIG. 6b also illustrates options the dashboard user can access from the mobile alerts dashboard, including opt-in invitations. As can be seen from screen 174, dashboard users, such as the carrier, provider, publisher or aggregator, can choose between ringtones, wallpapers, applications, hardware, carrier surveys, opt-in invitations, opt-in subscribers, 3^{rd} party surveys, admin or log out. If the dashboard user selects the opt-in invitations, an opt-in invitations screen is displayed 176. See FIG. 6c. The opt-in invitation screen 176 displays the types of invitations that can be provided to users. Invitations or messages are pushed to the wireless devices of the user and can include an invitation to participate in a survey, an invitation to purchase a ringtone or song, an invitation to purchase wallpaper, an invitation to purchase applications and an invitation to purchase hardware. This screen 176 also displays which invitations are active, the number of days before the invitation is sent out, the number of opt-in subscribers and the percentage of the opt-in subscribers that have opted in. From this screen 176, the dashboard user can select a main button to return to the main screen or select a log out button to log out of the dashboard.

FIG. 6c illustrates screens of the invitations that the dashboard users (carrier, provider, publisher or aggregator) can access from the mobile alerts dashboard screen 174. A carrier surveys opt-in invitations screen 178 is displayed. From the carriers surveys opt-in invitations screen 178, dashboard users can change the number of days before sending the invitations, change the status of the invitation, view a bar graph of the number of opt-in subscribers and a bar graph of the percentage of opt-in subscribers that are participating in the survey. Also displayed are the numerical number of opt-in subscribers and the numerical percentage of opt-in subscribers that are participating in the survey. The screen 178 also displays an audit trail so that the dashboard user can view who made the last change, what the change was and when the change took place. From this screen 178, the dashboard users can select a main button to return to the main screen, select an opt-in invitations button to return to the opt-in invitations screen or select a log out button to log out of the dashboard.

FIG. 6d illustrates screens of additional invitations that the dashboard users can access from the mobile alerts dashboard. A 3^{rd} party surveys opt-in invitations screen 180 is displayed. From the 3^{rd} party surveys opt-in invitations screen 180, the dashboard users (carrier, provider, publisher or aggregator) can change the number of days before sending the invitations, change the status of the invitation, view a bar graph of the number of opt-in subscribers and a bar graph of the percentage of opt-in subscribers that are participating in the option to receive messages to participate in the 3^{rd} party survey. Also displayed are the numerical number of opt-in subscribers and the numerical percentage of opt-in subscribers that are participating. The screen 180 also displays an audit trail so that the dashboard user can view who made the last change, what the change was and when the change took place. From this screen 180, the dashboard user can select a main button to return to the main screen, select an opt-in invitations button to return to the opt-in invitations screen or select a log out button to log out of the dashboard.

Also illustrated in FIG. 6d is a hardware opt-in invitations screen 182. From the hardware opt-in invitations screen, the dashboard user can change the number of days before sending the invitations, change the status of the invitation, view a bar graph of the number of opt-in subscribers and a bar graph of the percentage of opt-in subscribers that are participating in the option to receive messages to purchase hardware. Also displayed are the numerical number of opt-in subscribers and the numerical percentage of opt-in subscribers that are participating. The screen also displays an audit trail so that the carrier, provider, publisher, or aggregator can view who made the last change, what the change was and when the change took place. From this screen 182, the dashboard user can select a main button to return to the main screen, select an opt-in invitations button to return to the opt-in invitations screen or select a log out button to log out of the dashboard.

FIG. 6e illustrates screens of additional invitations that the dashboard user can access from the mobile alerts dashboard. An applications opt-in invitations screen is displayed 184. From the applications opt-in invitations screen 184, the dashboard user can change the number of days before sending the invitations, change the status of the invitation, view a bar graph of the number of opt-in subscribers and a bar graph of the percentage of opt-in subscribers that are participating in the option to purchase an application. Also displayed are the numerical number of opt-in subscribers and the numerical percentage of opt-in subscribers that are participating in the application invitation. The screen 184 also displays an audit trail so that the dashboard user can view who made the last change, what the change was and when the change took place. From this screen 184, the dashboard user can select a main button to return to the main screen, select an opt-in invitations button to return to the opt-in invitations screen or select a log out button to log out of the dashboard.

A wallpapers opt-in invitations screen 186 is also displayed in FIG. 6e. From the wallpapers opt-in invitations screen 186, the dashboard user can change the number of days before sending the invitations, change the status of the invitation, view a bar graph of the number of opt-in subscribers and a bar graph of the percentage of opt-in subscribers that are participating in the option to receive messages to purchase wallpaper. Also displayed are the numerical number of opt-in subscribers and the numerical percentage of opt-in subscribers that are participating. The screen 186 also displays an audit trail so that the dashboard user can view who made the last change, what the change was and when the change took place. From this screen 186, the dashboard user can select a main button to return to the main screen, select an opt-in invitations button to return to the opt-in invitations screen or select a log out button to log out of the dashboard.

A ringtones opt-in invitations screen 188 is displayed 188 in FIG. 6f. From the ringtones opt-in invitations screen 188, the dashboard user can change the number of days before sending the invitations, change the status of the invitation, view a bar graph of the number of opt-in subscribers and a bar graph of the percentage of opt-in subscribers that are participating in the option to purchase a ringtone or song. Also displayed are the numerical number of opt-in subscribers and the numerical percentage of opt-in subscribers that are participating in the ringtones invitation. The screen 188 also displays an audit trail so that the dashboard user can view who made the last change, what the change was and when the change took place. From this screen 188, the dashboard user can select a main button to return to the main screen, select an opt-in invitations button to return to the opt-in invitations screen or select a log out button to log out of the dashboard.

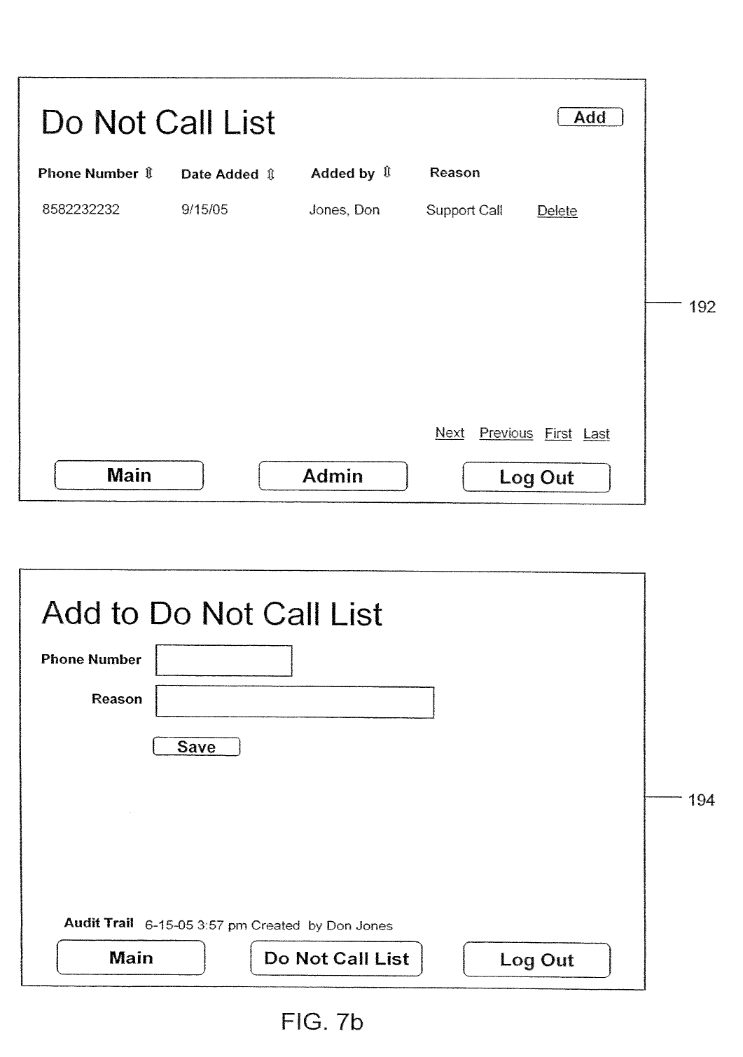

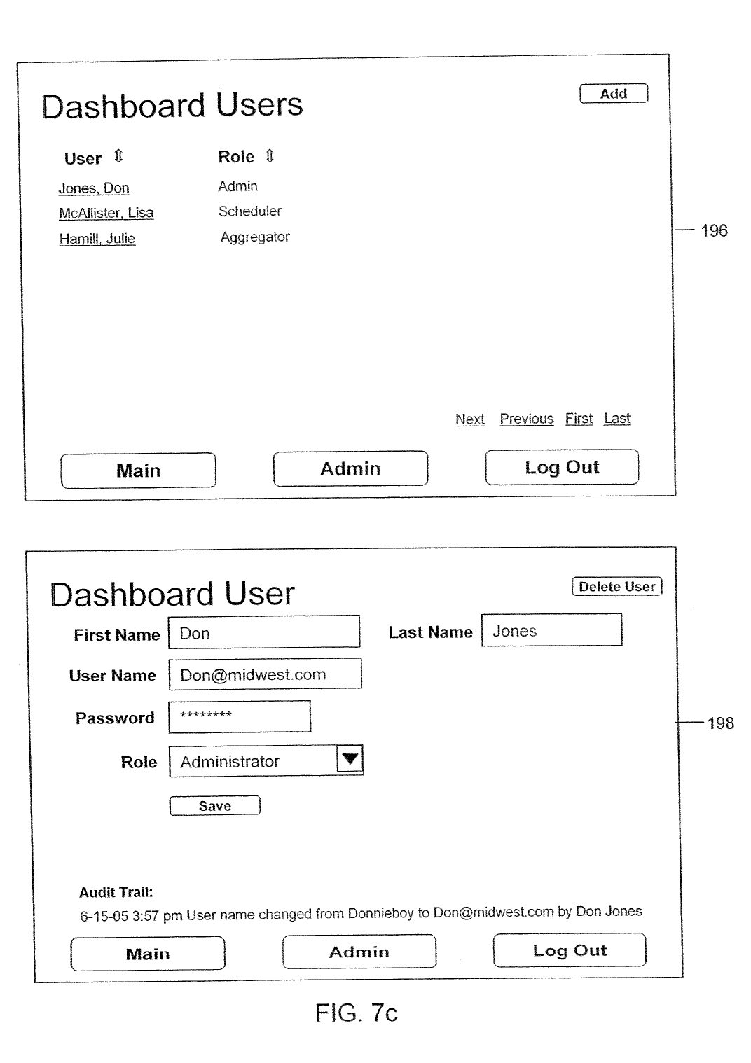

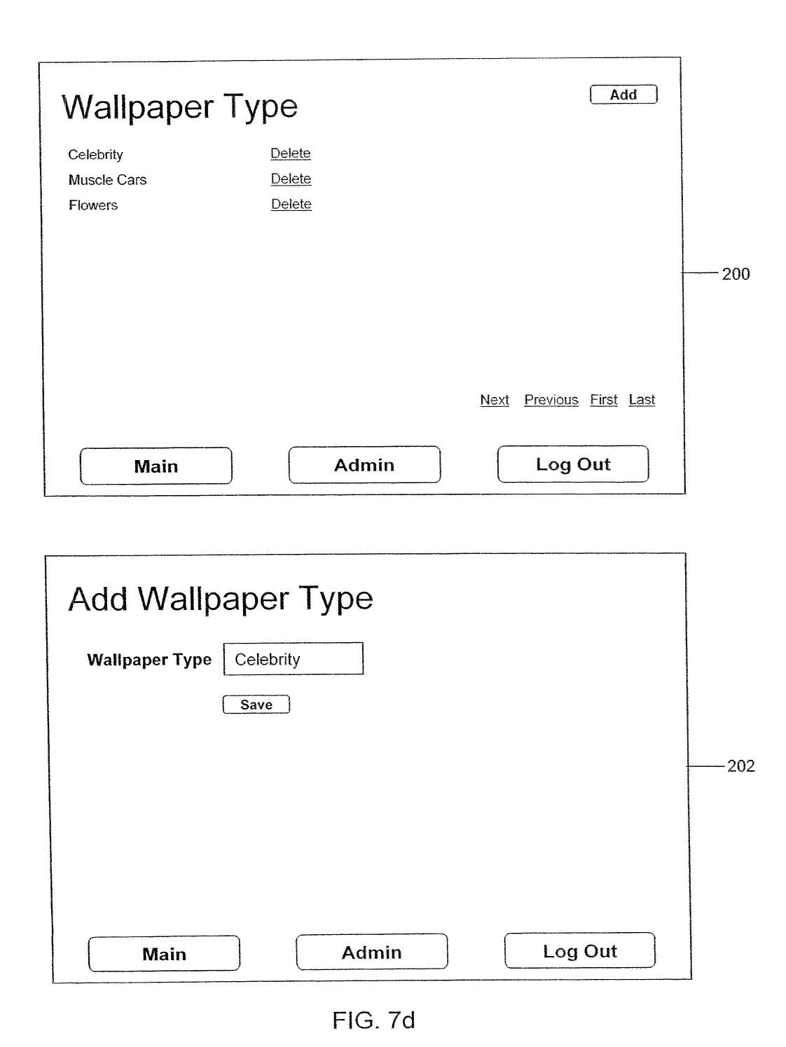

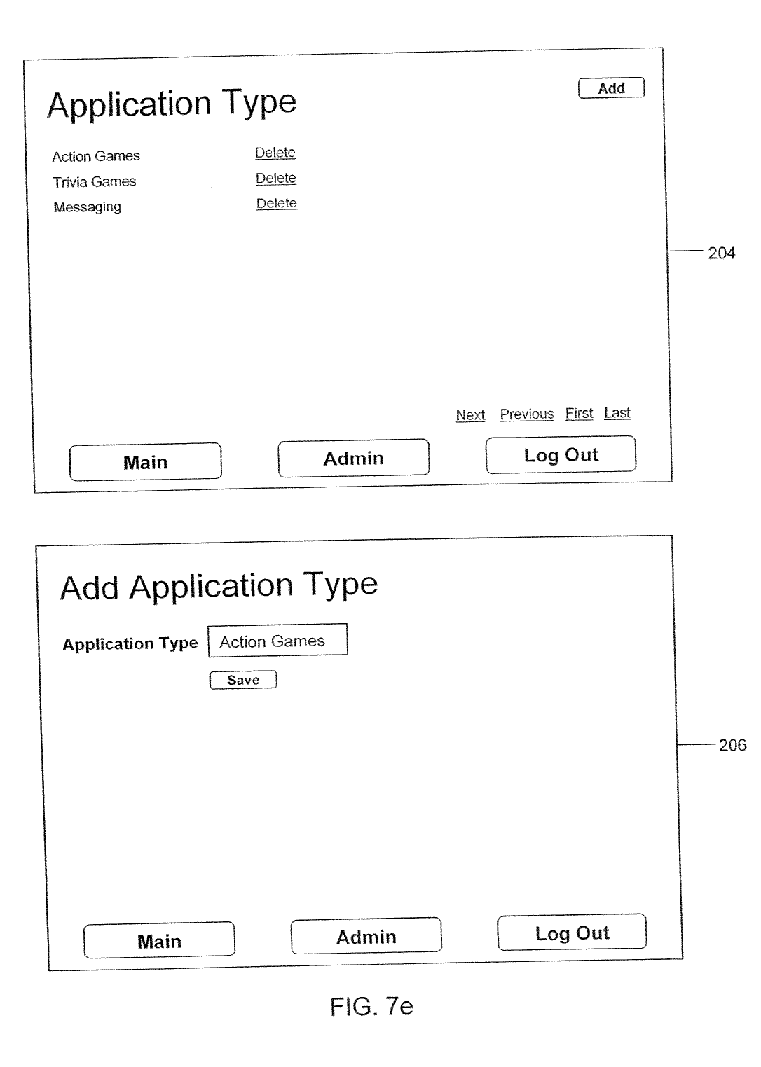

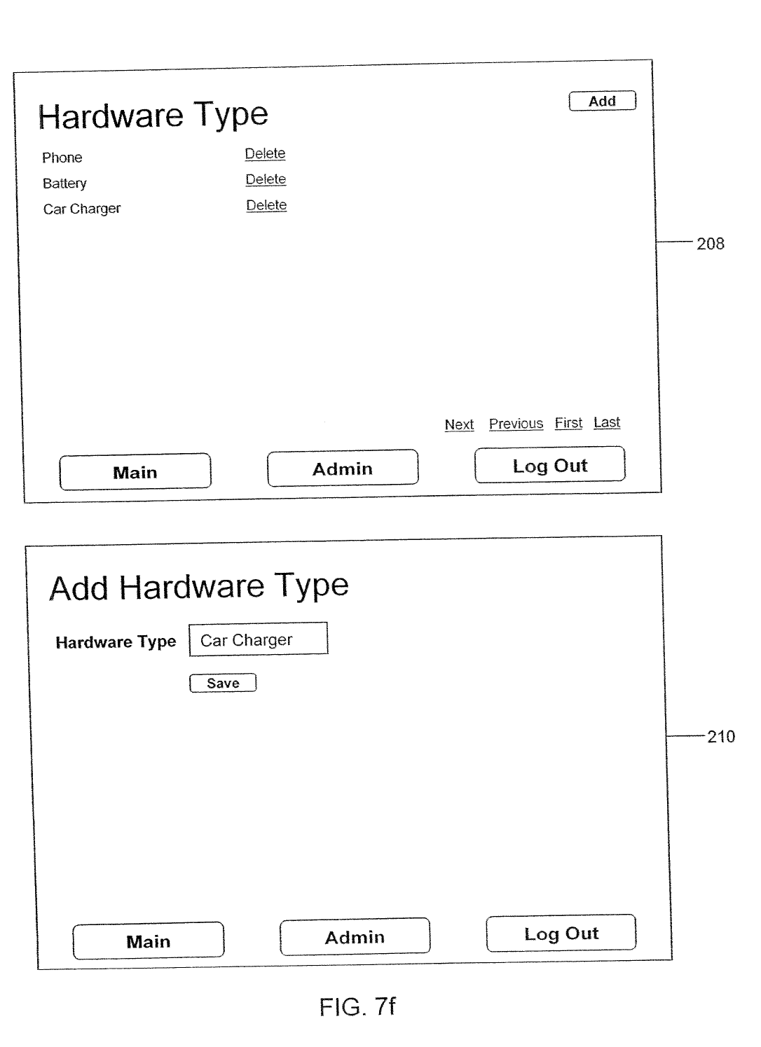

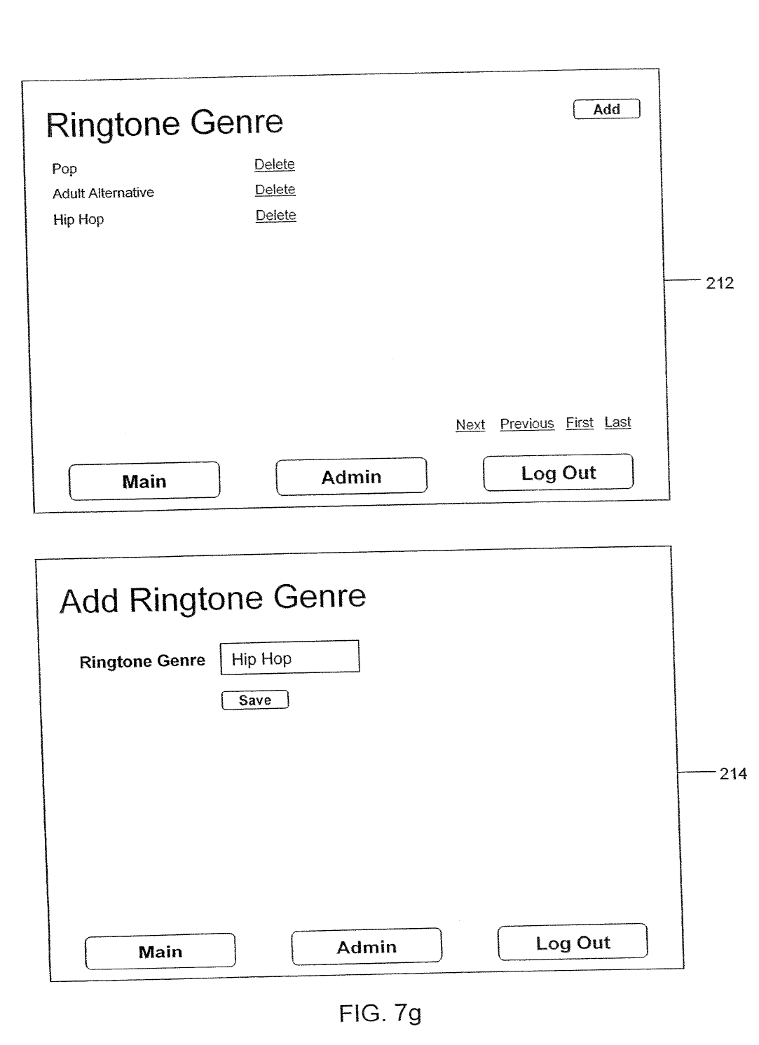

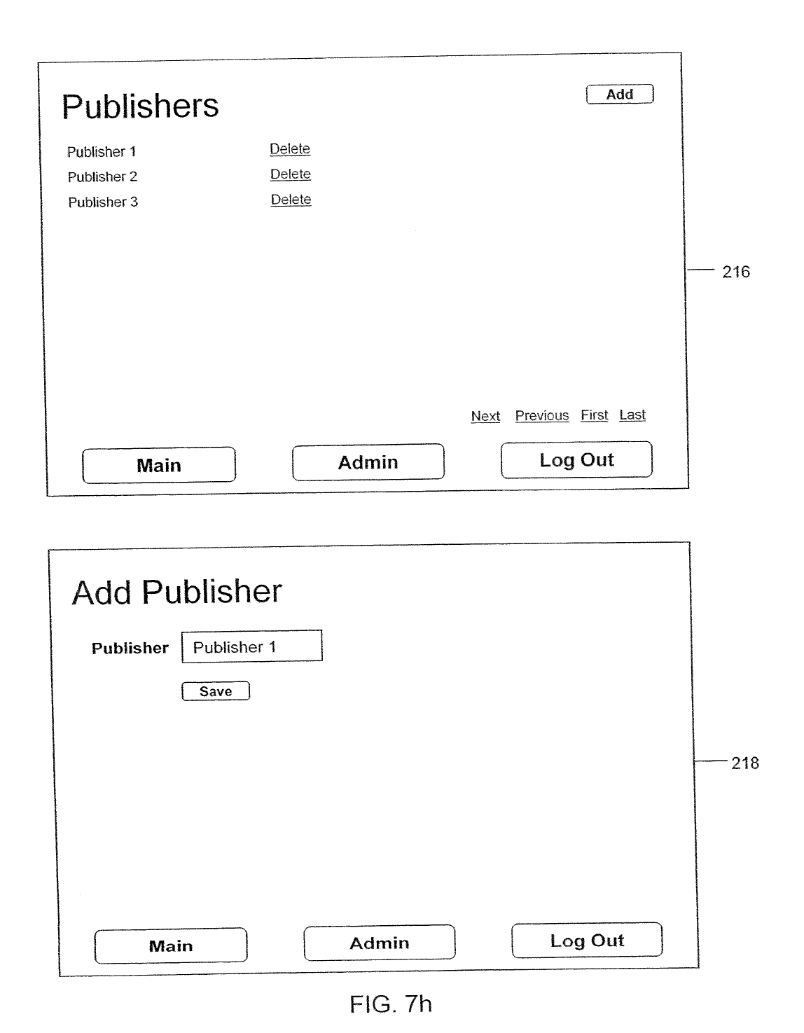

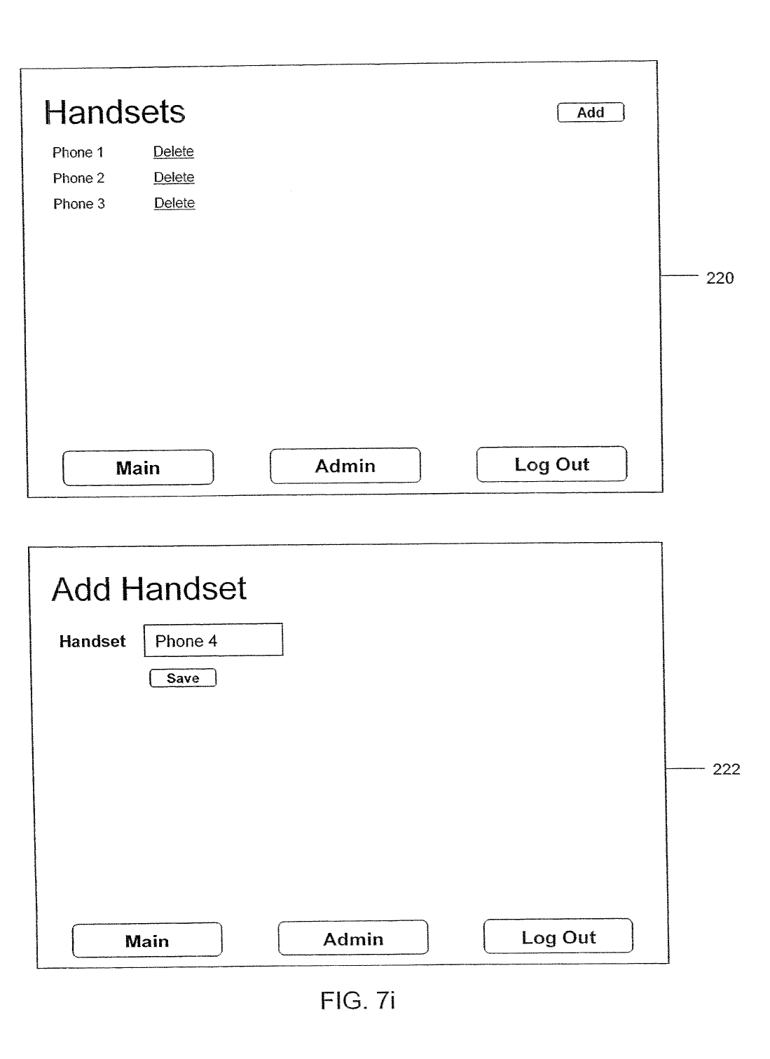

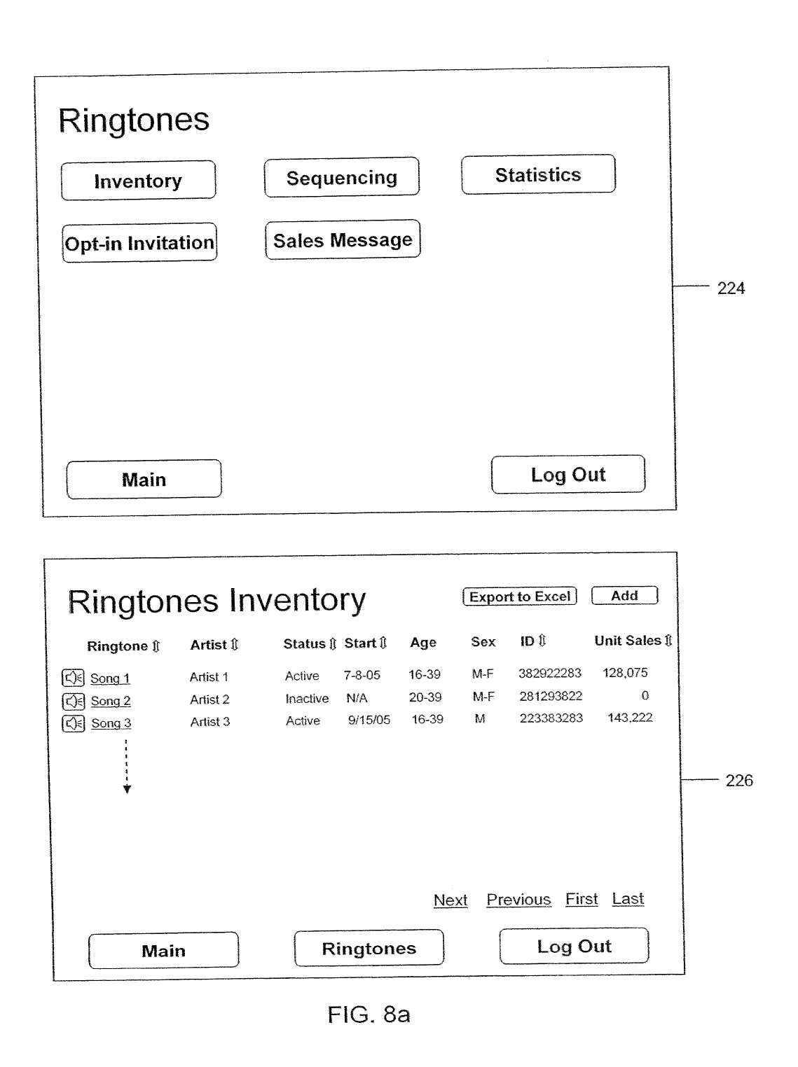

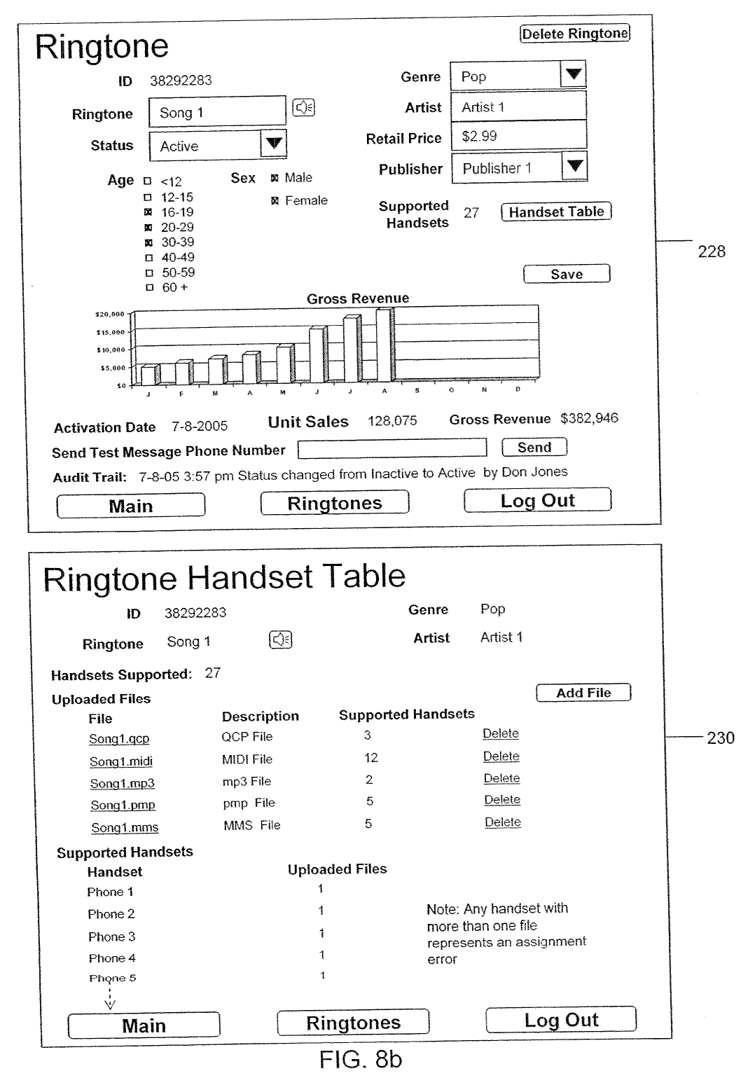

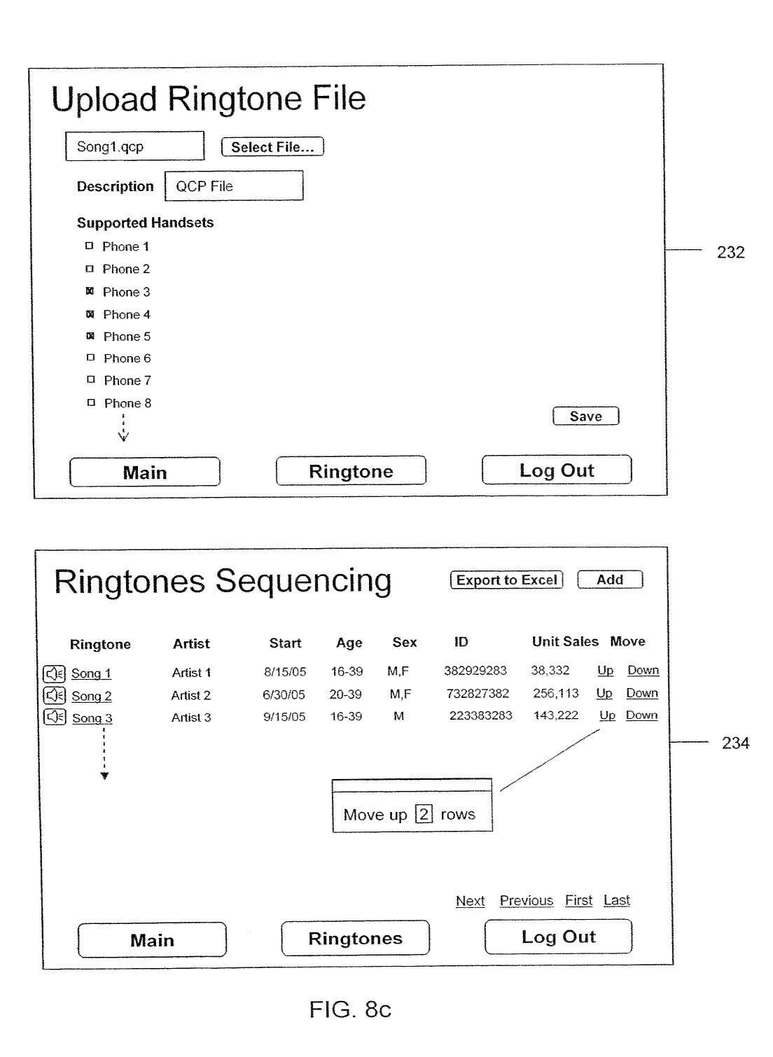

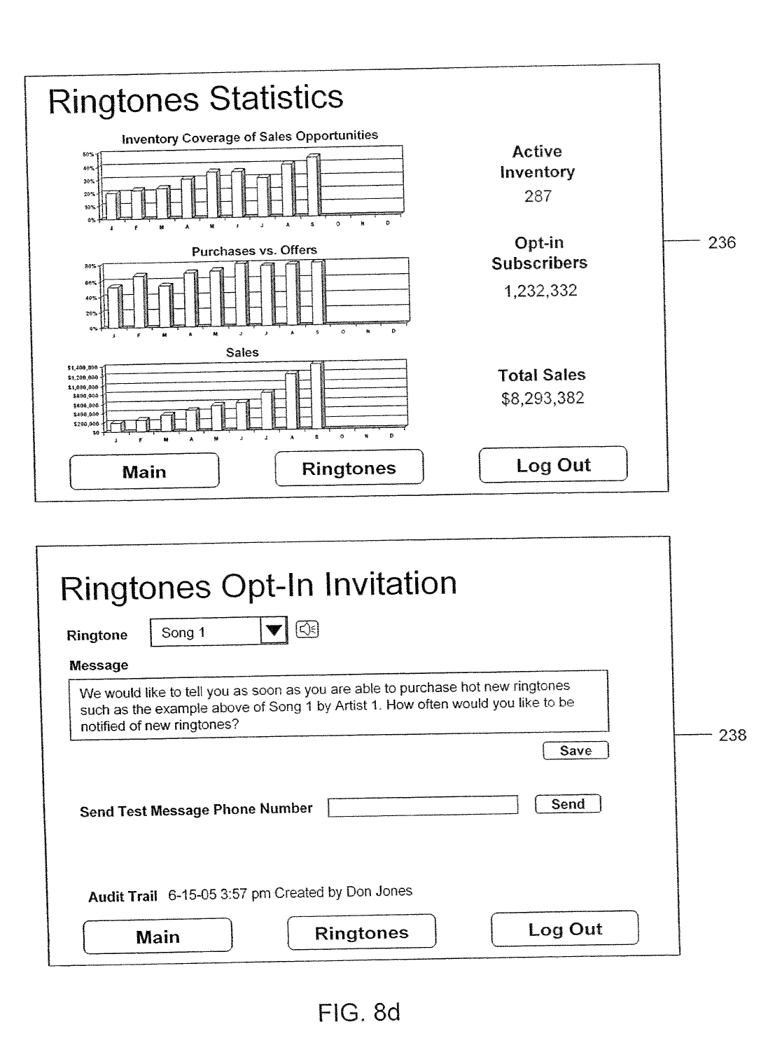

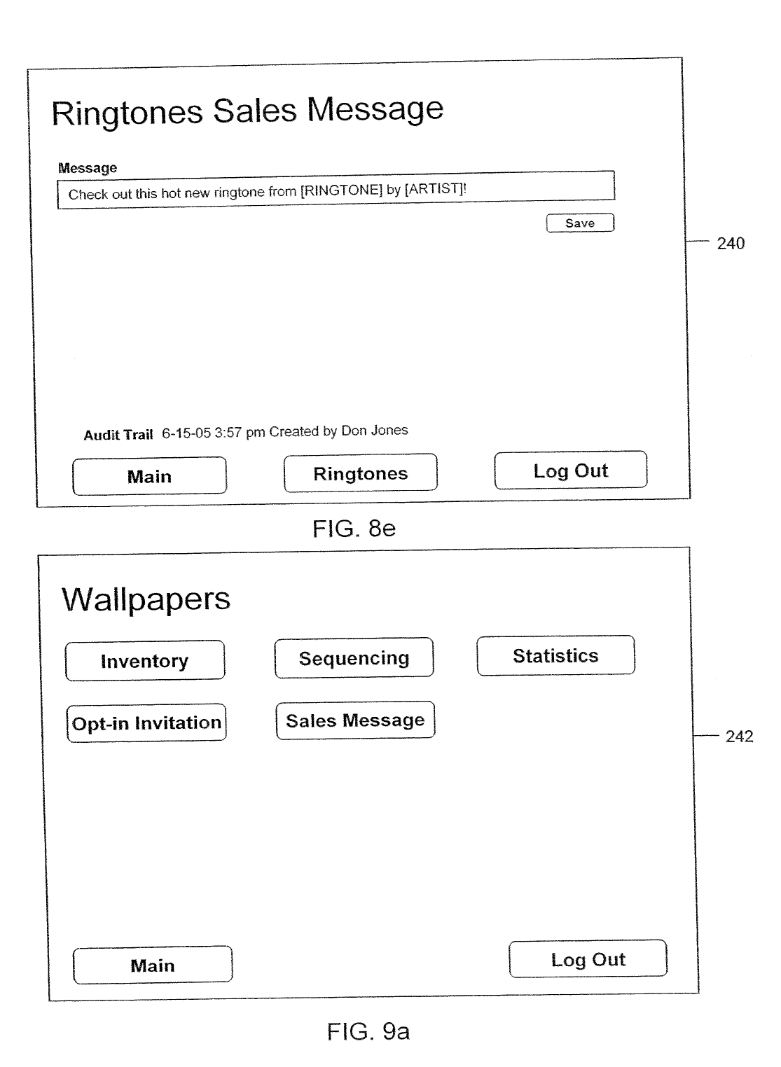

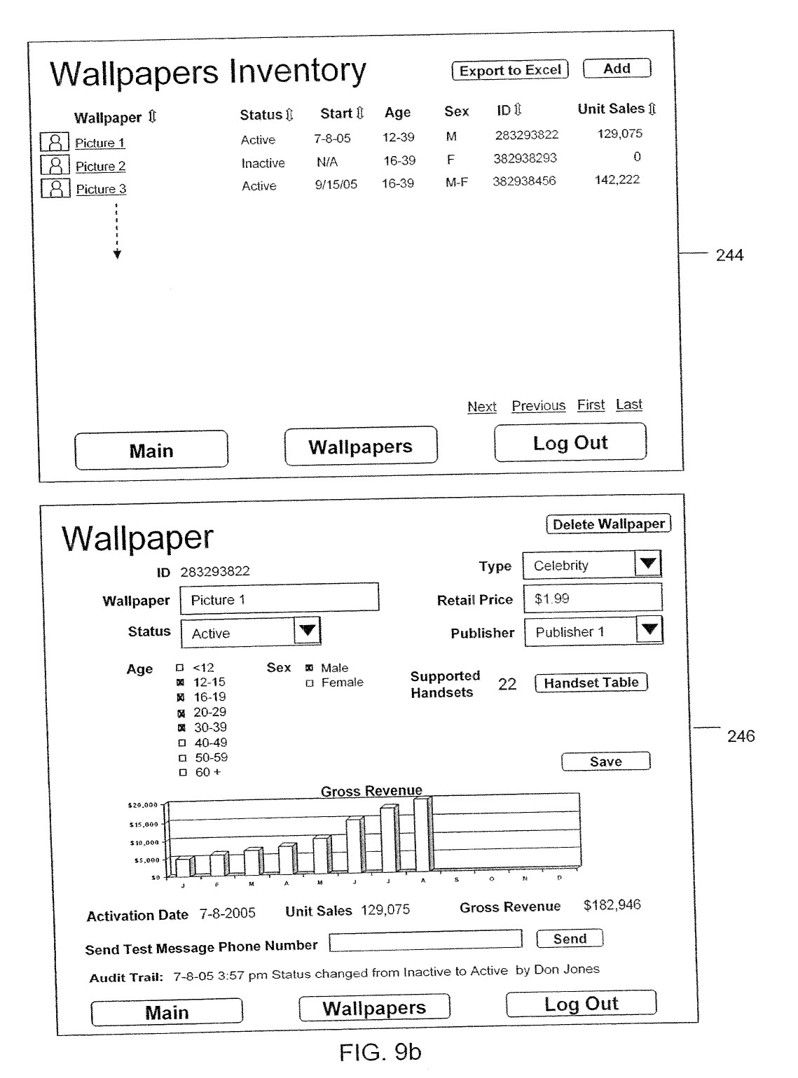

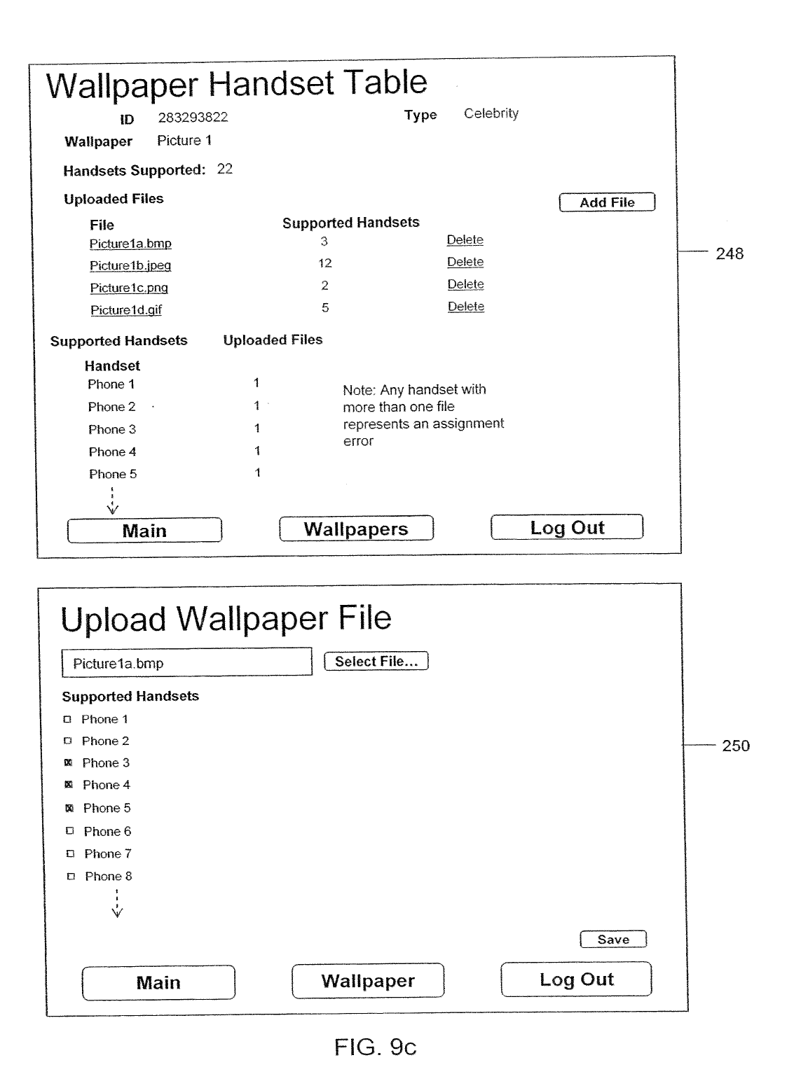

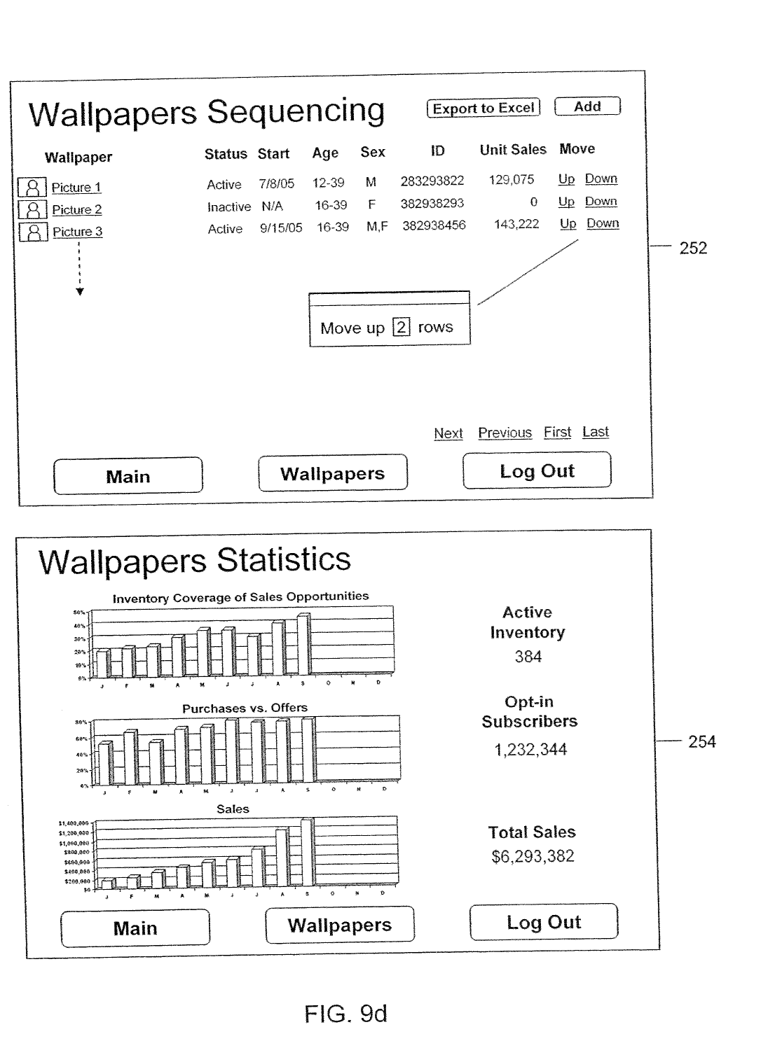

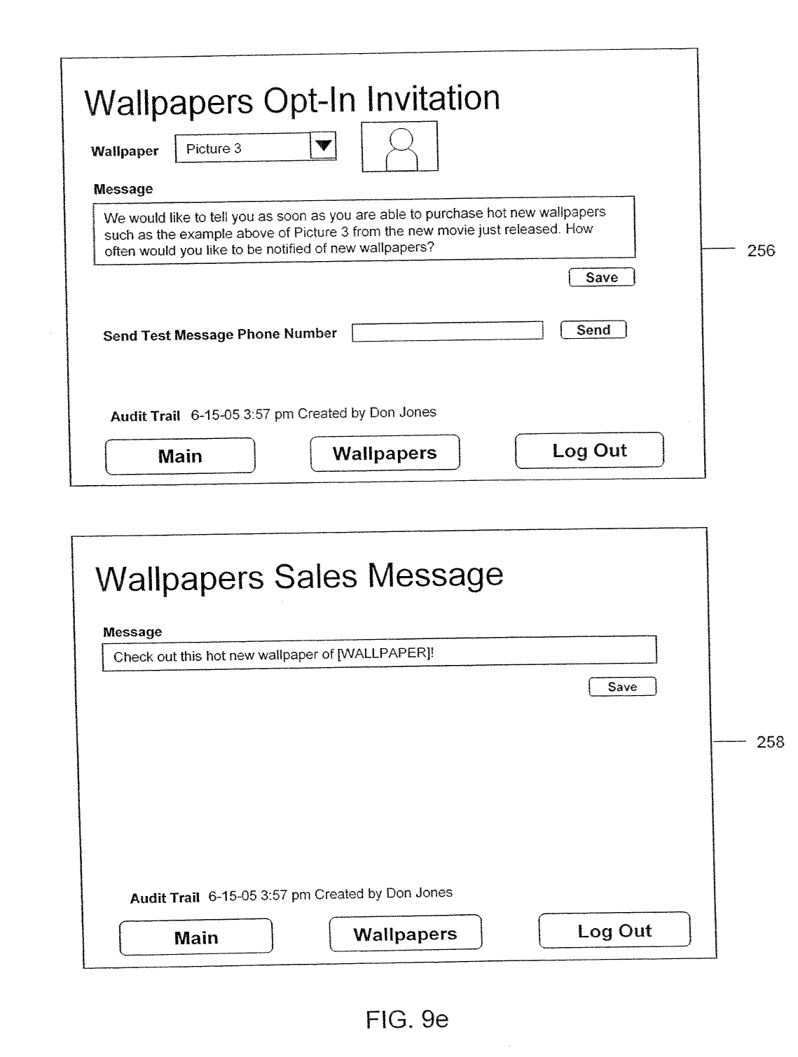

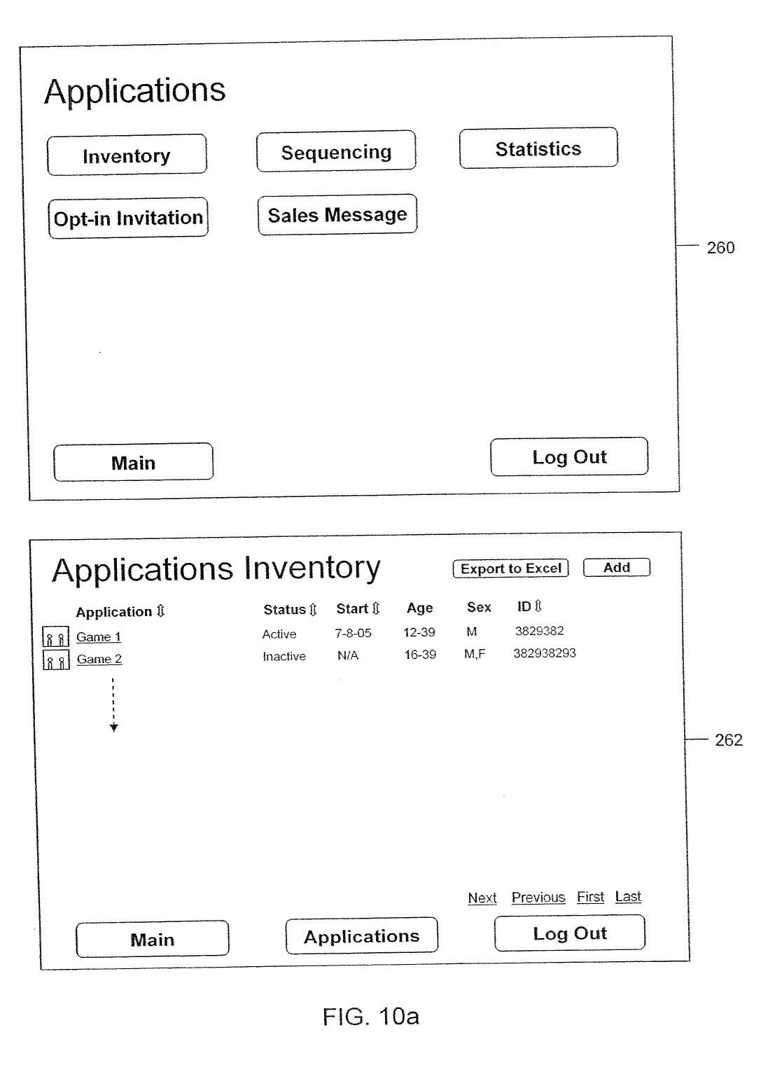

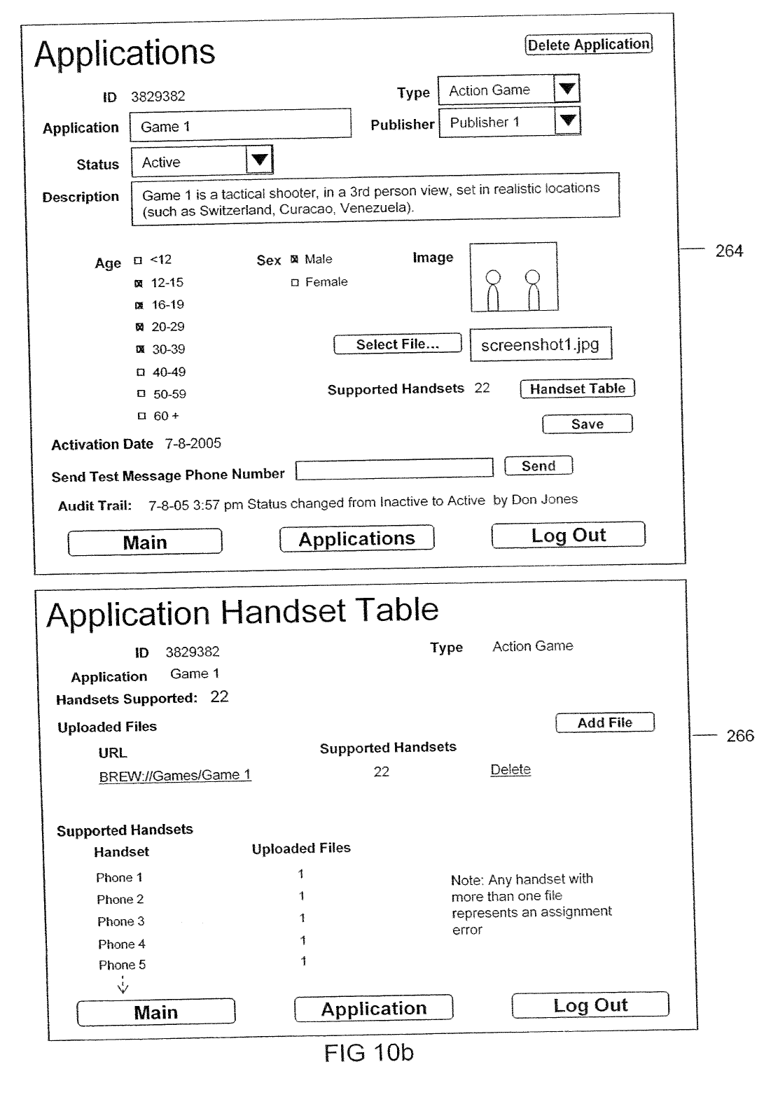

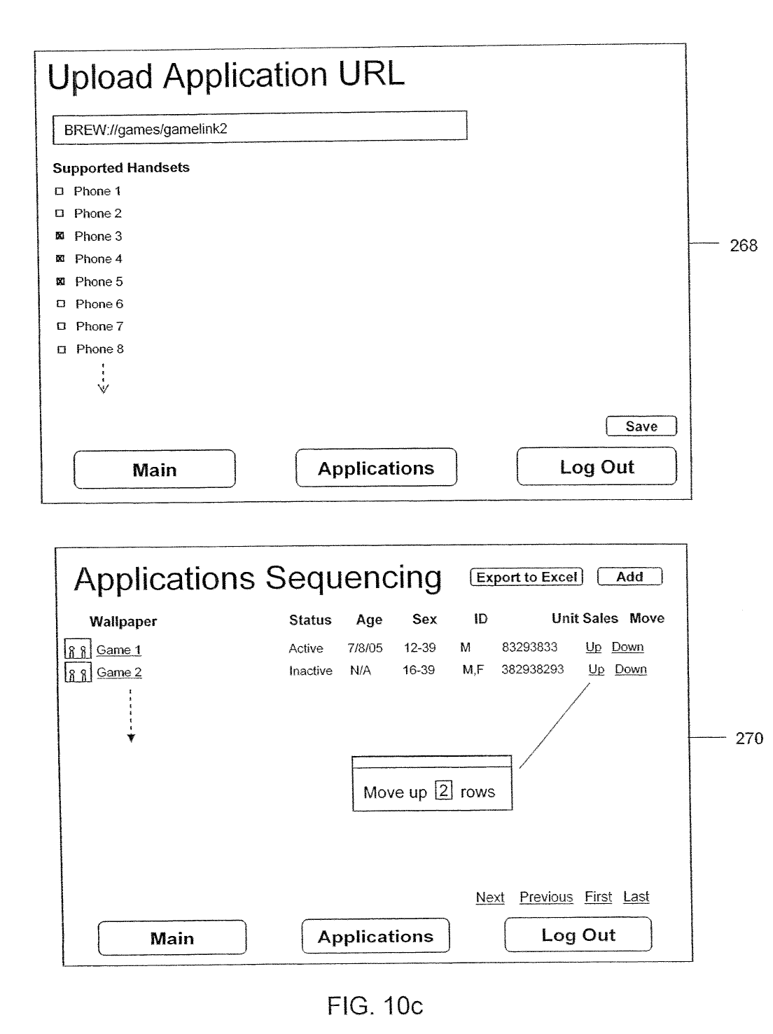

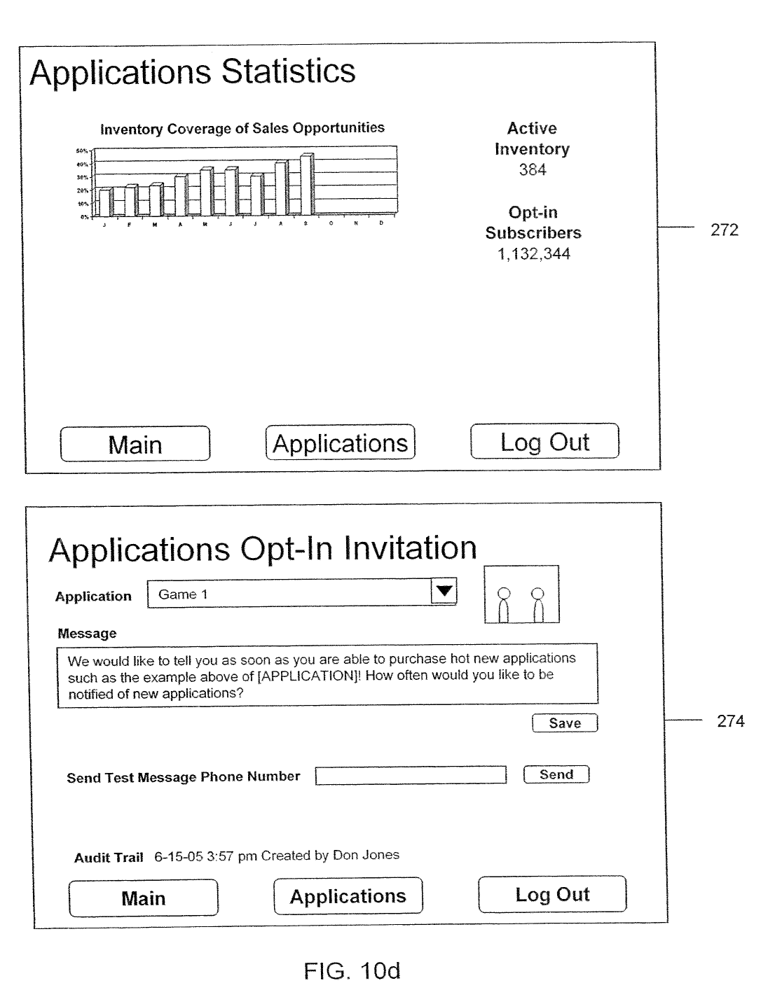

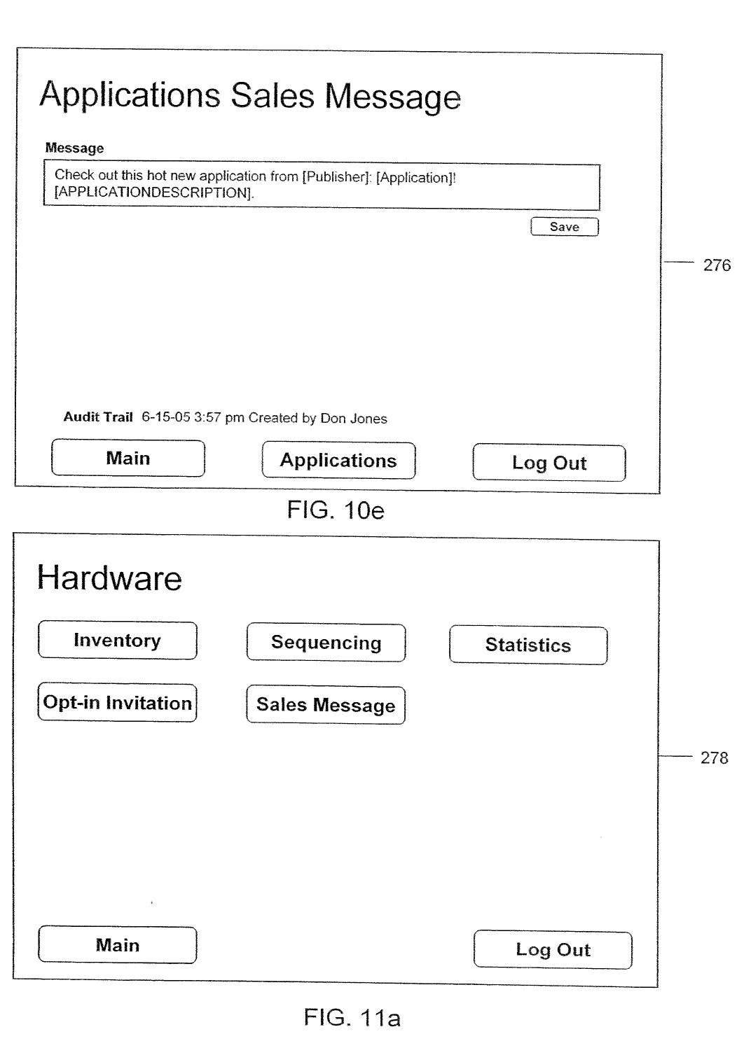

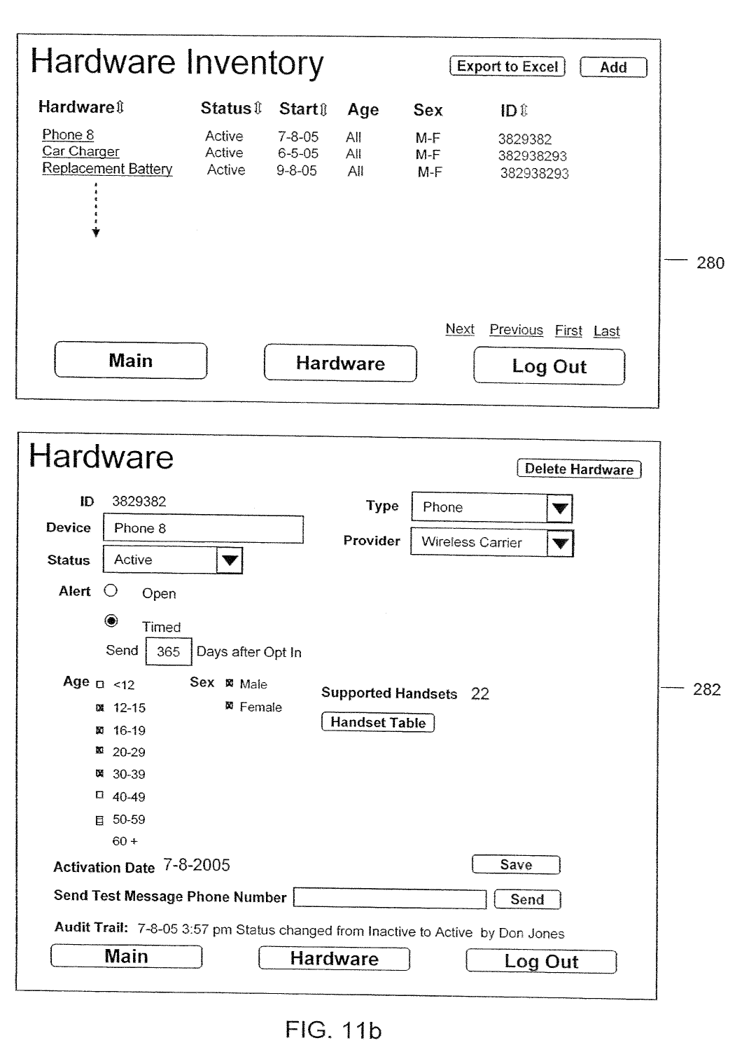

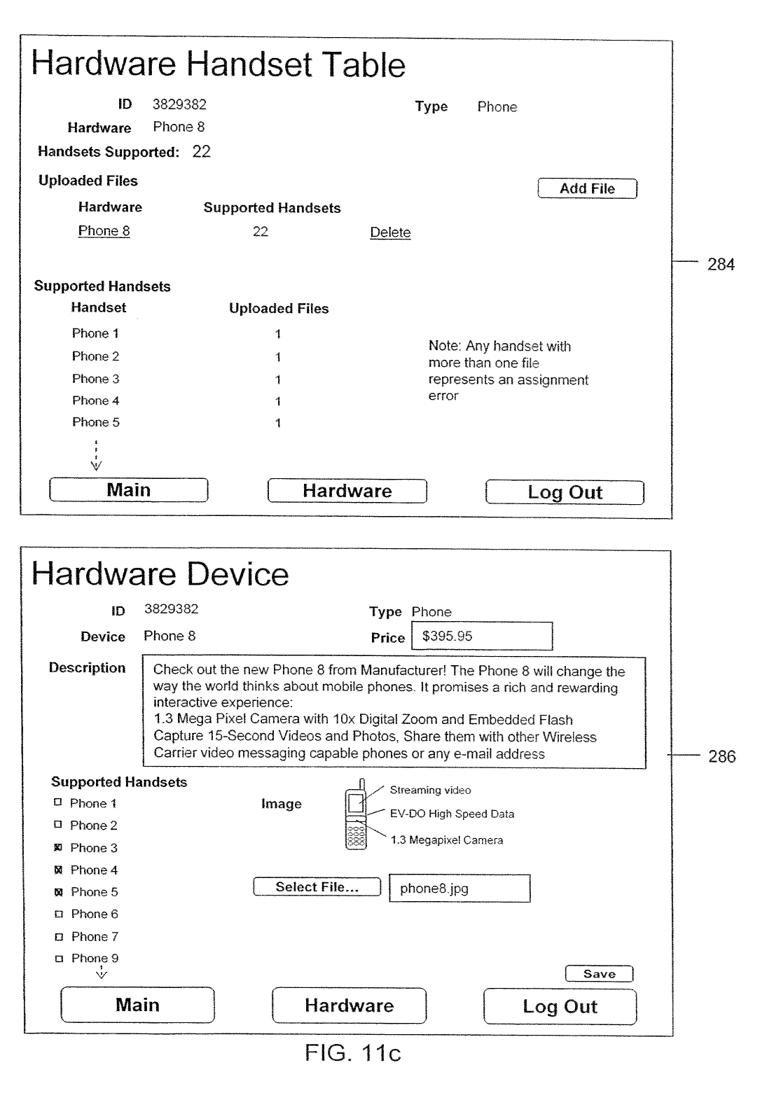

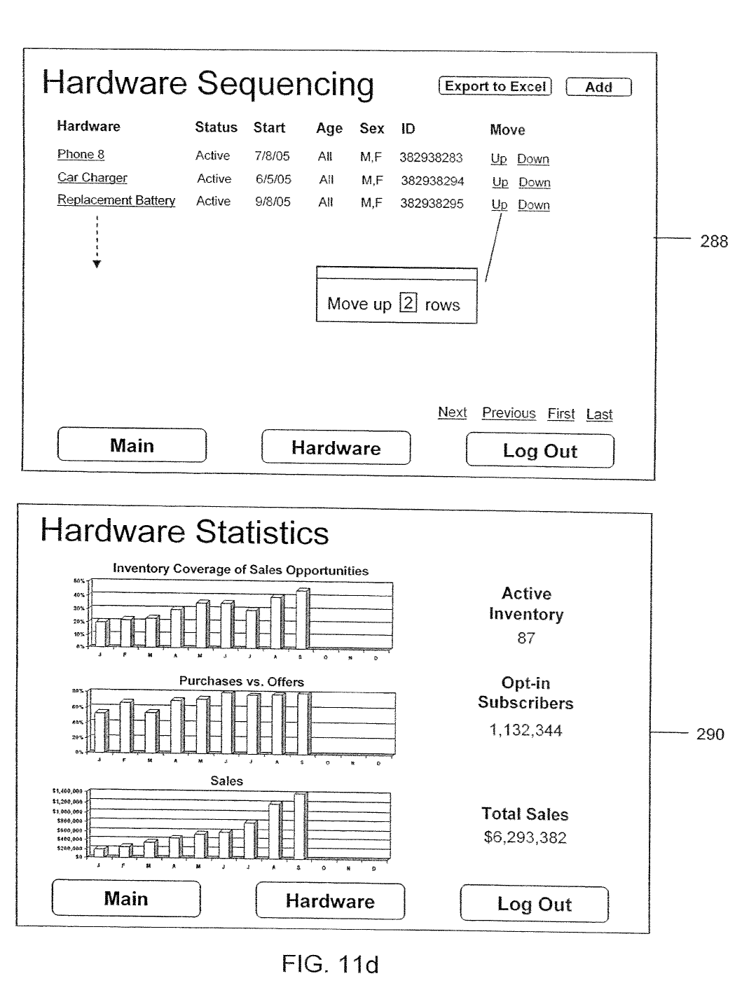

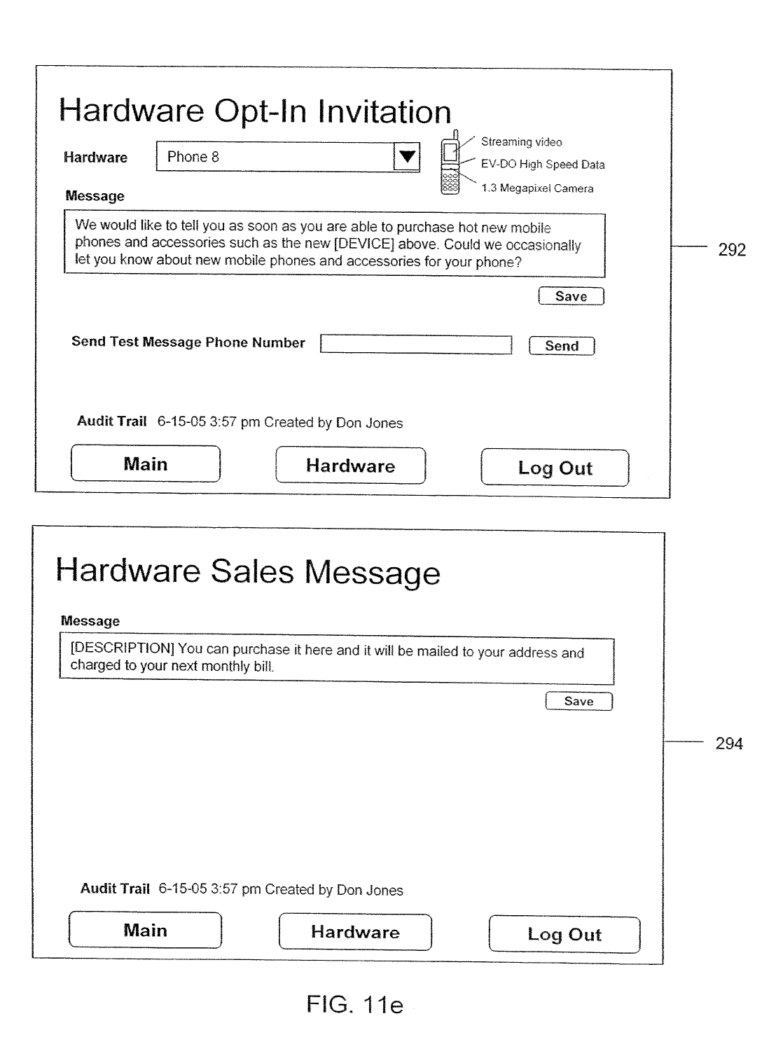

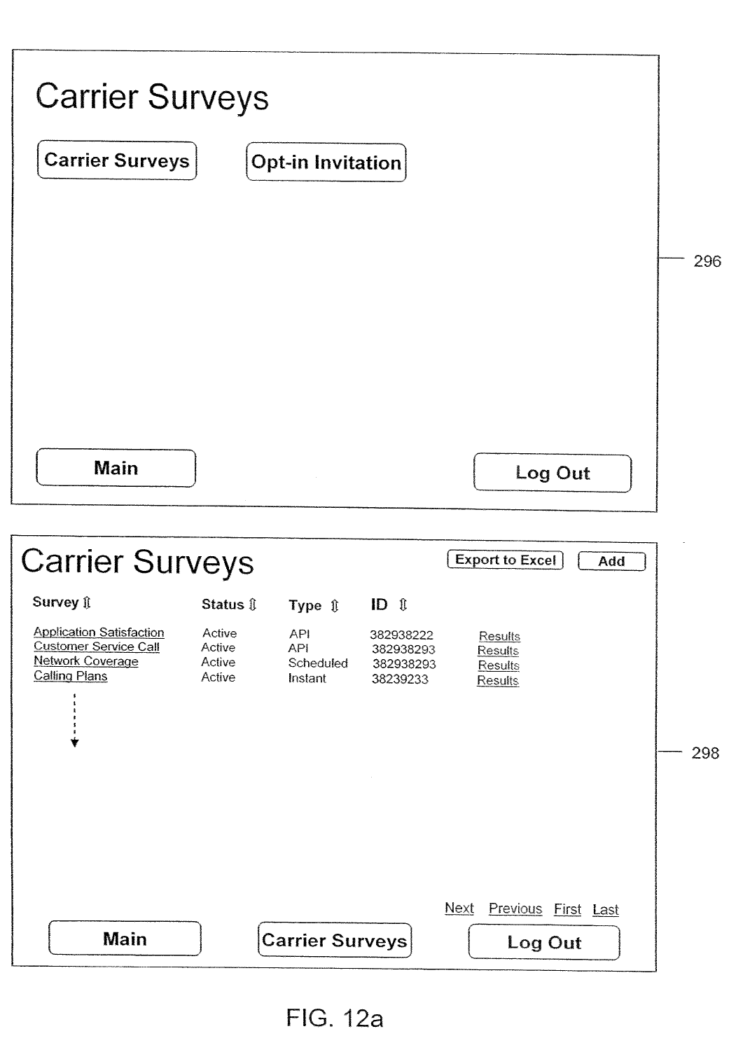

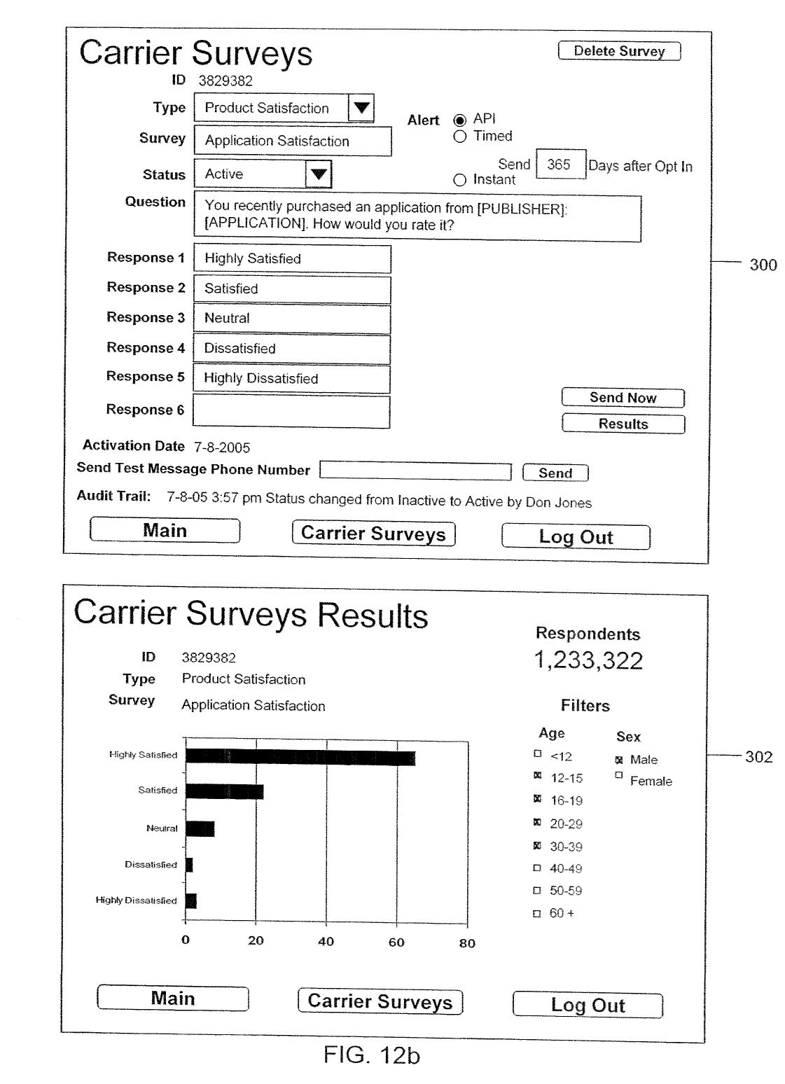

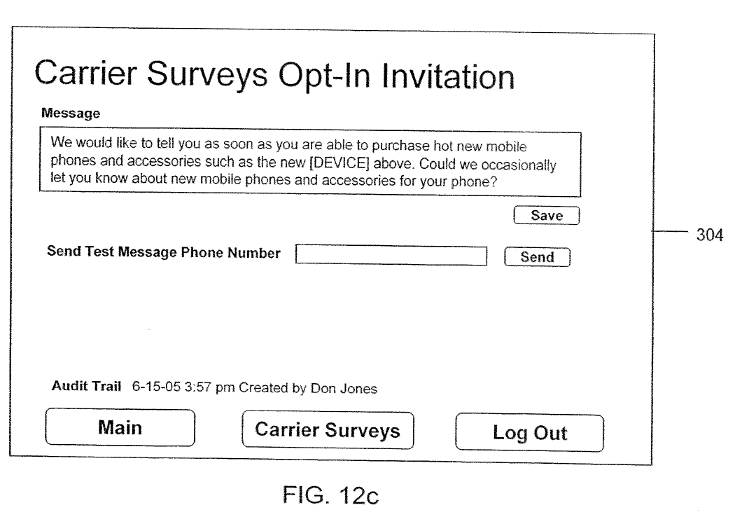

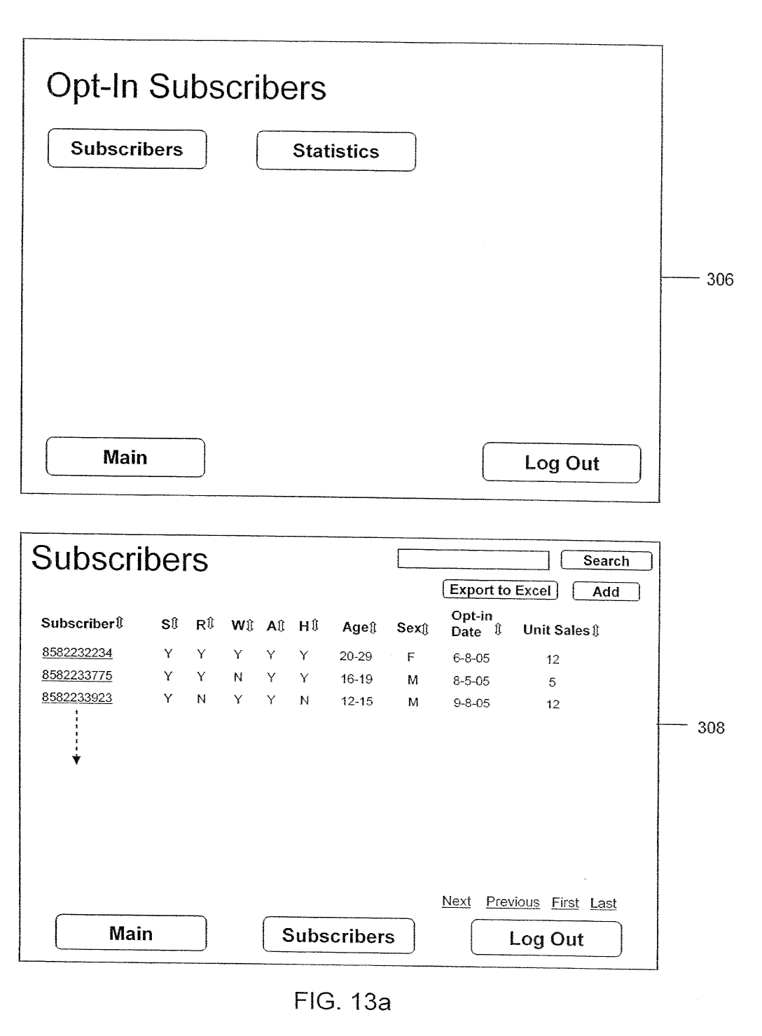

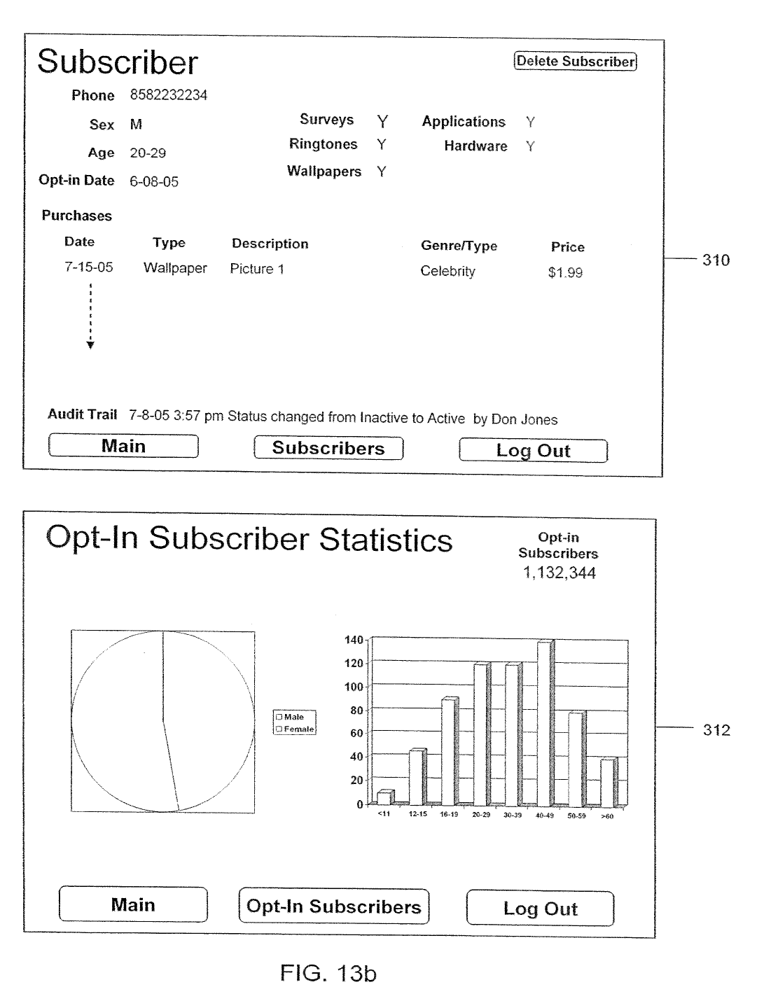

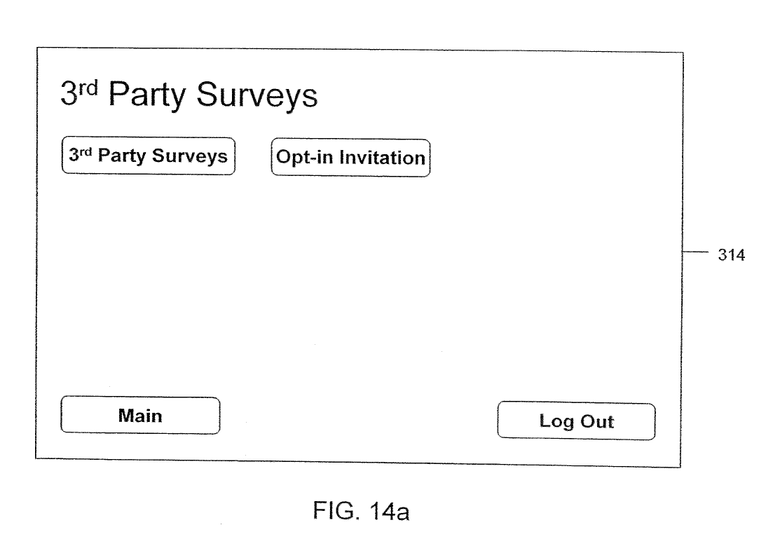

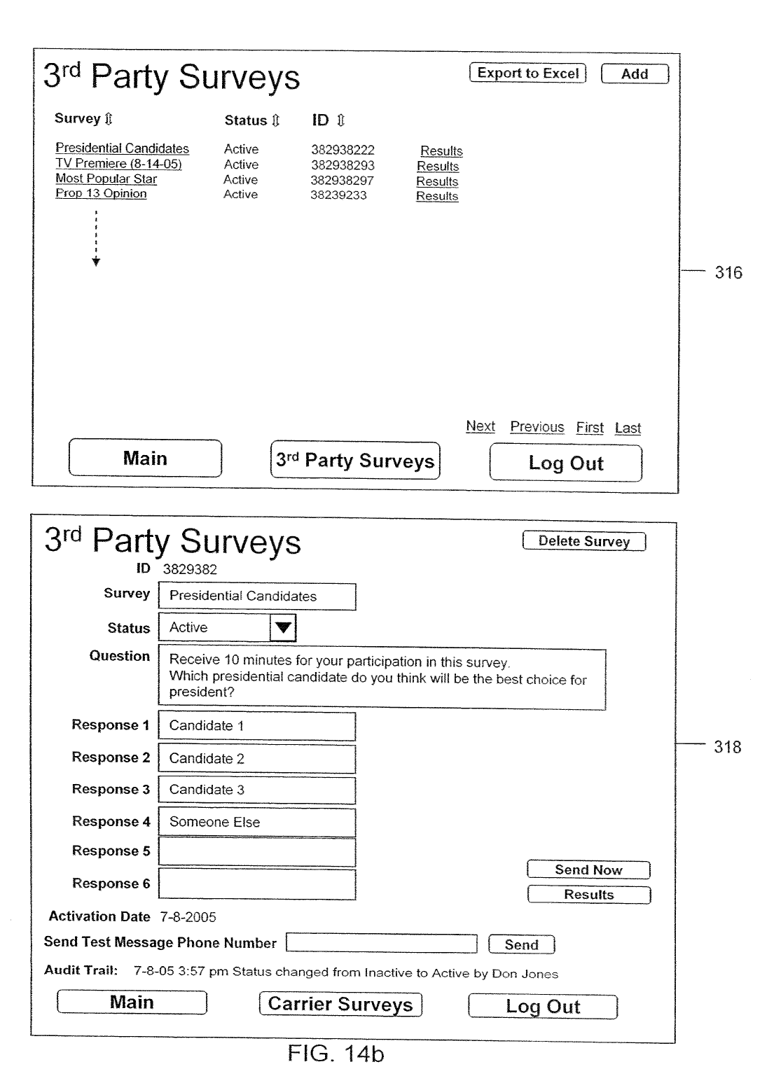

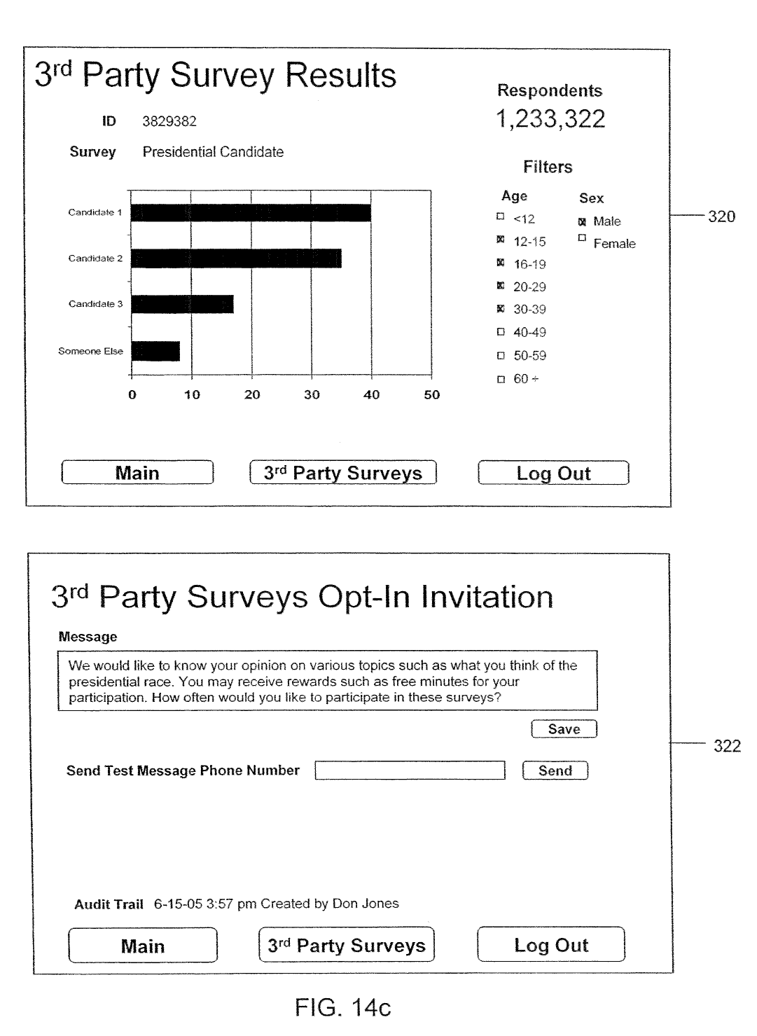

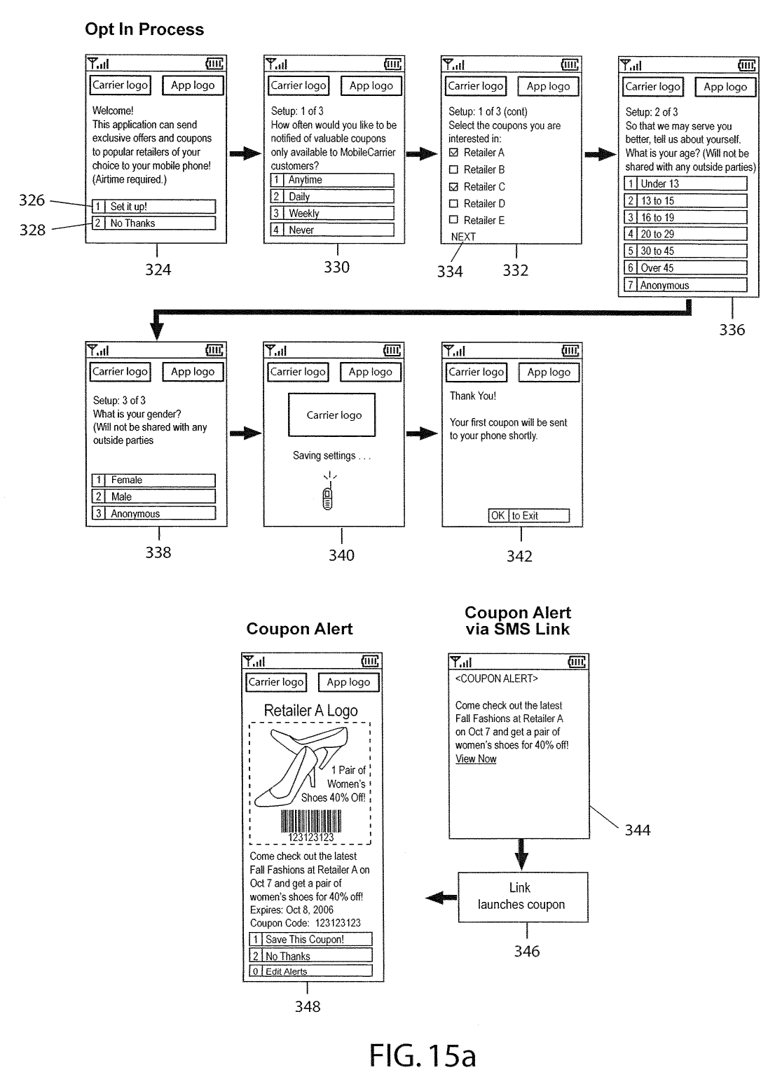

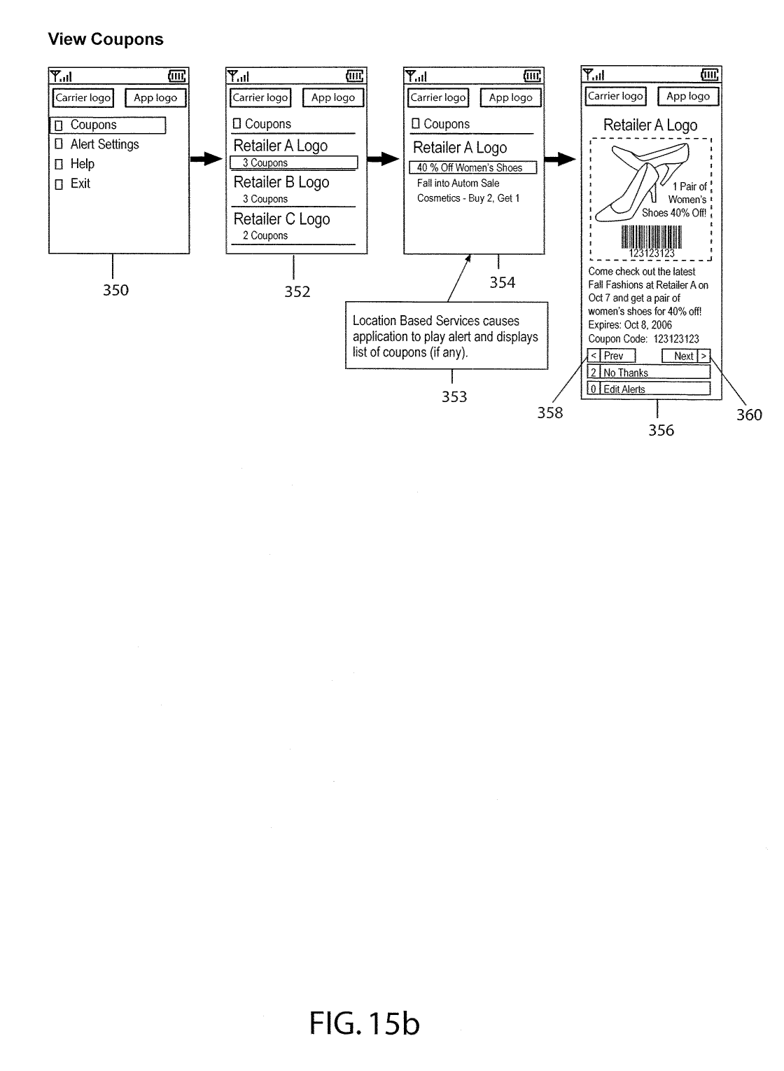

FIG. 7a illustrates options the dashboard user can access for the admin screen 190 of the mobile alerts dashboard. As can be seen from screen 190, the dashboard user can choose between user, publisher, handsets, do not call list, ringtones genre, wallpaper type, application type, hardware type, main or log out. If the dashboard user selects the do not call list, a do not call screen 192 is displayed. See FIG. 7b. The do not call screen 192 displays a list of users who have requested that they not be called. The list displays the phone number of the user, the date the user was added, and who added the user and the reason the user was added. From this screen 192, additional users can be added or deleted and the dashboard user can select a main button to return to the main screen, select an admin button to return to the admin screen or select a log out button to log out of the dashboard.

If the dashboard user selects the add button from the do not call list screen 192, an add to do not call list screen 194 is displayed. See FIG. 7b. The add do not call screen 194 allows the dashboard user to enter the phone number of a user who wants to be added to the do not call list as well as the reason why the user wanted to be added to the list. Upon selecting the save button, the user is added to the do not call list. The screen 194 displays an audit trail so that the dashboard user can view who added the user and when the user was added. From this screen 194, the dashboard user can select a main button to return to the main screen, select a do not call list button to return to the do not call screen or select a log out button to log out of the dashboard.

If the dashboard user selects the users button from the admin screen 190, the dashboard users screen 196 (See FIG. 7c) displays a list of dashboard users of the system, such as the administrator, the scheduler, the provider, the carrier and the aggregator. From this screen 196, additional dashboards users can be added or deleted by selecting the add button on dashboard user screen 198. In screen 198, the dashboard user can be added or deleted by entering the name of the person; the person's email address, the person's password and the person's role in the system. The screen 198 displays an audit trail so that the dashboard user can view who made the addition or deletion and when the addition or deletion was made. The dashboard can select a main button to return to the main screen, select an admin button to return to the admin screen 190 or select a log out button to log out of the dashboard. See FIG. 7c.

If the dashboard user selects the wallpaper type button from the admin screen 190, the wallpaper type screen 200 displays a list of wallpaper currently available for purchase. From this screen 200, additional wallpaper can be added by selecting the add button. Selecting the add button causes an add wallpaper type screen 202 to be displayed where new wallpaper can be added by entering the name of the wallpaper and selecting the save button. The dashboard user can select a main button to return to the main screen, select an admin button to return to the admin screen 190 or select a log out button to log out of the dashboard. See FIG. 7d.

If the dashboard user selects the application type button from the admin screen 190, the application type screen 204 displays a list of applications currently available for purchase. From this screen 204, additional applications can be added by selecting the add button on display screen 204. Selecting the add button causes an add application type screen 206 to be displayed where new applications can be added by entering the name of the application and selecting the save button. The dashboard user can select a main button to return to the main screen, select an admin button to return to the admin screen 190 or select a log out button to log out of the dashboard. See FIG. 7e.

If the dashboard user selects the hardware type button from the admin screen 190, the hardware type screen 208 displays a list of hardware currently available for purchase. From this screen 208, additional hardware can be added by selecting the add button on display screen 208. Selecting the add button causes an add hardware type screen 210 to be displayed where new hardware can be added by entering the name of the hardware and selecting the save button. The dashboard user can select a main button to return to the main screen, select an admin button to return to the admin screen 190 or select log out button to log out of the dashboard. See FIG. 7f.

If the dashboard user selects the ringtone genre button from the admin screen 190, the ringtone genre screen 212 displays a list of ringtones currently available for purchase. From this screen 212, additional ringtones can be added by selecting the add button. Selecting the add button causes an add ringtone genre screen 214 to be displayed where new ringtones can be added by entering the name of the ringtone or song and selecting the save button. The dashboard user can select a main button to return to the main screen, select an admin button to return to the admin screen 190 or select a log out button to log out of the dashboard. See FIG. 7g.

If the dashboard user selects the publishers button from the admin screen 190, the publishers screen 216 displays a list of current publishers. From this screen 216, publishers can be added by selecting the add button. Selecting the add button causes an add publisher screen 218 to be displayed where new publishers can be added by entering the name publisher selecting the save button. The dashboard user can select a main button to return to the main screen, select an admin button to return to the admin screen 190 or select a log out button to log out of the dashboard. See FIG. 7h.

If the dashboard user selects the handsets button from the admin screen 190, the handsets screen 220 displays a list of available handsets. From this screen 220, additional handsets can be added by selecting the add button. Selecting the add button causes an add handset screen 222 to be displayed where new handsets can be added by entering the new handset and selecting the save button. The dashboard user can select a main button to return to the main screen, select an admin button to return to the admin screen 190 or select a log out button to log out of the dashboard. See FIG. 7i.

FIG. 8a illustrates options the dashboard user can access from the ringtones screen 224 of the mobile alerts dashboard. As can be seen from screen 224, the dashboard user can choose between inventory, sequencing, statistics, opt-in invitation, sales message, main or log out. If the dashboard user selects the inventory, an inventory screen is displayed 226. See FIG. 8a. The ringtones inventory screen 226 displays a list of ringtones in the system. The list displays the song or ringtone, the artist, the status of the ringtone or song, when the ringtone or song will be available for downloading, the age range of the user that would most likely be interested in the ringtone or song, the sex of the user that would most likely be interested in the ringtone or song, the id of the ringtone or song and how many of each ringtone or song has been sold. From this screen 226, additional ringtones can be added or the ringtones can be exported to an excel spreadsheet. The dashboard user can select a main button to return to the main screen, select a ringtones button to return to the ringtones screen 224 or select a log out button to log out of the dashboard.

From the ringtones inventory screen 226, the dashboard user can select a song or ringtone for viewing specific details. As shown in FIG. 8b, upon selecting a specific ringtone or song, a ringtone screen 228 is displayed. The ringtone screen 228 allows the status of the ringtone to be changed, lists the genre, the artist, the price for downloading, the publisher and the number (types) of handsets or wireless devices the ringtone or song will support. Also listed are the age range for the most likely user and the sex of the most likely user. Furthermore, this screen 228 allows the dashboard user to view a bar graph of the gross revenue by month generated from the sales of a specific ringtone or song, the number of the ringtone or song sold, the total gross revenue and the date the ringtone or song was activated. The dashboard user can also type in a specific telephone number to send a test message to ensure the system is working properly. The screen 228 also displays an audit trail so that the dashboard user can view who made the last change, what the change was and when the change took place. From this screen 228, the dashboard user can select a main button to return to the main screen, select ringtones button to return to the ringtones screen 224 or select a log out button to log out of the dashboard.

From the ring tone screen 228, the dashboard user can select a handset table button to view a ringtone handset table screen 230. The ringtone handset table screen 230 allows the dashboard user to custom load inventories by handset model for each product or ringtone, so that users will only receive purchase invitations for ringtones that are compatible with the model of handsets or wireless devices they own. This information includes the genre of the ringtone or song, the artist and the number (types) of handsets or wireless devices the ringtone or song will support. It also lists the types of files available for downloading, such as MIDI, MP3, etc. From this screen 230, the dashboard user can select a main button to return to the main screen, select the ringtone button to return to the ringtone screen 224 or select a log out button to log out of the dashboard.

From the ring tone handset table screen 230, the dashboard user can select an add file button to add a new ringtone. Upon selecting the add file button, an upload ringtone file screen 232 is displayed. See FIG. 8c. The upload ringtone file screen 232 allows a new ringtone or song to be added by first selecting the file to upload, filling in the description of the file and selecting the handsets that the ringtone or song will support. Upon uploading the ringtone or song and saving it, the dashboard user can select a main button to return to the main screen, select a ringtone button to return to the ringtone screen 224 or select a log out button to log out of the dashboard.

If the dashboard user selects the sequencing button from the ringtones screen 224 (See FIG. 8a), a ring tones sequencing screen 234 is displayed. See FIG. 8c. This screen 234 displays the sequence or priority that the messages are sent to users about purchasing ringtones or songs will be sent, so the dashboard user can increase or decrease the priority of particular wallpaper in the scheduled list. When sending out a purchase invitation, the dashboard automatically sends a message to the user showing the highest priority ringtone or song available for purchase that has not previously been sent. From this screen 234, the dashboard user can select a main button to return to the main screen, select a ringtones button to return to the ringtones screen 224 or select a log out button to log out of the dashboard.

If the dashboard user selects the statistics button from the ringtones screen 1224 (See FIG. 8a), a ring tones statistics screen 236 is displayed. See FIG. 8d. This screen 236 displays the statistics of the sales of the ringtones. Specifically, the screen 236 displays a bar graph of the inventory coverage of sales opportunities by month, a bar graph of the purchases vs. the offers by month and a bar graph of the sales by month. Additionally, this screen 236 shows the number of available ringtones, the number or opt-in subscribers and the total sales amount by dollars. From this screen 238, the dashboard user can select a main button to return to the main screen, select a ringtones button to return to the ringtones screen 224 or select a log out button to log out of the dashboard.

If the dashboard user selects the opt-in invitation button from the ringtones screen 224 (See FIG. 8a), a ring tones opt-in invitation screen 238 is displayed. See FIG. 8d. This screen 238 allows the dashboard user to enter a message or invitation to be sent to users inviting the users to purchase a ringtone or song. The dashboard user can also type in a specific telephone number to send a test message to ensure the system is working properly. The screen 238 also displays an audit trail so that the dashboard user can view who made the last change, what the change was and when the change took place. From this screen 236, the dashboard user can select a main button to return to the main screen, select ringtones button to return to the ringtones screen 224 or select a log out button to log out of the dashboard.

If the dashboard user selects the sales message button from the ringtones screen 224 (See FIG. 8a), a ring tones sales message screen 240 is displayed. See FIG. 8e. This screen 240 allows the dashboard user to enter a sales message be sent to users inviting the users preview the ringtone or song for purchase. The screen 240 also displays an audit trail so that the dashboard user can view who sent the message and when it was sent. From this screen 240, the dashboard user can select a main button to return to the main screen, select ringtones button to return to the ringtones screen or select a log out button to log out of the dashboard.

FIG. 9a illustrates options the dashboard user can access for the wallpapers screen 242 of the mobile alerts dashboard. As can be seen from screen 242, the dashboard user can choose between inventory, sequencing, statistics, opt-in invitation, sales message, main or log out. If the dashboard user selects the inventory button, a wallpapers inventory screen 244 is displayed. See FIG. 9b. The wallpaper inventory screen 244 displays a list of available wallpaper in the system. The list displays the wallpaper, the status of the wallpaper, when the wallpaper will be available for downloading, the age range of the user that would most likely be interested in the wallpaper, the sex of the user the would most likely be interested in the wallpaper, the id of the wallpaper and how many of each wallpaper has been sold. From this screen 244, additional wallpapers can be added or the wallpaper can be exported to an excel spreadsheet. The dashboard user can select a main button to return to the main screen, select a wallpapers button to return to the wallpapers screen 242 or select a log out button to log out of the dashboard.

From the wallpapers inventory screen 244, the dashboard user can select a wallpaper to view specific details of. As shown in FIG. 7b, upon selecting specific wallpaper, a wallpaper screen 246 is displayed. The wallpaper screen 246 allows the status of the wallpaper to be changed, lists type of wallpaper, the price for downloading, the publisher and the number (types) of handsets or wireless devices the ringtone or song will support. Also listed are the age range for the most likely user and the sex of the most likely user. Furthermore, this screen 246 allows the dashboard user to view a bar graph of the gross revenue by month generated from the sales of a specific wallpaper, the number of the wallpaper sold, the total gross revenue and the date the wallpaper was activated. The dashboard user can also type in a specific telephone number to send a test message to ensure the system is working properly. The screen 246 also displays an audit trail so that the dashboard user can view who made the last change, what the change was and when the change took place. From this screen 246, the dashboard user can select a main button to return to the main screen, select wallpapers button to return to the wallpapers screen 242 or select a log out button to log out of the dashboard.

From the wallpaper screen 246, the dashboard user can select a handset table button to view a wallpaper handset table screen 248. See FIG. 9c. The wallpaper handset table screen 248 allows the dashboard user to custom load inventories by handset model for each product or wallpaper, so that users will only receive purchase invitations for wallpapers that are compatible with the model of handsets or wireless devices they own. This information includes the type of wallpaper and the number (types) of handsets or wireless devices the wallpaper will support. It also lists the types of files available for downloading, such as bmp, jpeg, gif etc. From this screen 248, the dashboard user can select a lain button to return to the main screen, select a wallpaper button to return to the wallpaper screen 242 or select a log out button to log out of the dashboard.

From the wallpaper handset table screen 248, the dashboard user can select an add file button to add a new wallpaper. Upon selecting the add file button, an upload wallpaper file screen 250 is displayed. See FIG. 9c. The upload wallpaper file screen 250 allows a new wallpaper to be added by first selecting the file to upload and selecting the handsets that this wallpaper will support. Upon uploading the wallpaper and saving it, the dashboard user can select a main button to return to the main screen, select a wallpaper button to return to the wallpaper screen 242 or select a log out button to log out of the dashboard.

If the carrier, provide, publisher or aggregator selects the button from the wallpapers screen 242 (See FIG. 9a), a wallpapers sequencing screen 252 is displayed. See FIG. 9d. This screen 252 displays the sequence or priority that the messages are sent to users about purchasing wallpaper will be sent so the dashboard user can increase or decrease the priority of particular wallpaper in the scheduled list. When sending out a purchase invitation, the dashboard automatically sends a message to the user showing the highest priority wallpaper available for purchase that has not previously been sent. From this screen 252, the dashboard user can select a main button to return to the main screen, select a wallpapers button to return to the wallpapers screen 242 or select a log out button to log out of the dashboard.

If the dashboard user selects the statistics button from the wallpapers screen 242 (See FIG. 9a), a wallpapers statistics screen 254 is displayed. See FIG. 9d. This screen 254 displays the statistics of the sales of the wallpaper. Specifically, the screen 254 displays a bar graph of the inventory coverage of sales opportunities by month, a bar graph of the purchases vs. the offers by month and a bar graph of the sales by month. Additionally, this screen 254 shows the number of available wallpapers, the number or opt-in subscribers and the total sales amount by dollars. From this screen 254, the dashboard user an select a main button to return to the main screen, select a wallpapers button to return to the wallpapers screen 242 or select a log out button to log out of the dashboard.

If the dashboard user selects the opt-in invitation button from the wallpapers screen 242 (See FIG. 9a), a wallpapers opt-in invitation screen 256 is displayed. See FIG. 9e. This screen 256 allows the dashboard user to enter a message or invitation to be sent to users inviting the users to purchase wallpapers. The dashboard user can also type in a specific telephone number to send a test message to ensure the system is working properly. The screen 256 also displays an audit trail so that the dashboard user can view who made the last change and when the change took place. From this screen 256, the dashboard user can select a main button to return to the main screen, select wallpapers button to return to the wallpapers screen 242 or select a log out button to log out of the dashboard.

If the dashboard user selects the sales message button from the wallpapers screen 242 (See FIG. 9a), a wallpapers sales message screen 258 is displayed. See FIG. 9e. This screen 258 allows the dashboard user to enter a sales message be sent to users inviting the users preview the wallpapers for purchase. The screen 258 also displays an audit trail so that the dashboard user can view who sent the message and when it was sent. From this screen 258, the dashboard user can select a main button to return to the main screen, select wallpapers button to return to the wallpapers screen 242 or select a log out button to log out of the dashboard.

FIG. 10a illustrates options the dashboard user can access for the applications screen 260 of the mobile alerts dashboard. As can be seen from screen 260, the dashboard user can choose between inventory, sequencing, statistics, opt-in invitation, sales message, main or log out. If the dashboard user selects the inventory button, an applications inventory screen 262 is displayed. See FIG. 10a. The applications inventory screen 262 displays a list of available applications or games for purchase. The list displays the application, the status of the application, when the application will be available for downloading, the age range of the user that would most likely be interested in the wallpaper, the sex of the user the would most likely be interested in the application, the ID of the application and how many of each application has been sold. From this screen 262, additional applications can be added or the applications can be exported to an excel spreadsheet. The dashboard user can select a main button to return to the main screen, select an applications button to return to the applications screen 260 or select a log out button to log out of the dashboard.

From the applications inventory screen 262, the dashboard user can select an application to view specific details. As shown in FIG. 10b, upon selecting a specific application, an applications screen 264 is displayed. The applications screen 264 allows the status of the application to be changed, lists type of application, the price for downloading, the publisher and the number (types) of handsets or wireless devices the application will support. Also listed are the age range for the most likely user and the sex of the most likely user. Furthermore, from this screen 264 the dashboard user can view a bar graph of the gross revenue by month generated from the sales of a specific application, the number of the applications sold, the total gross revenue and the date the application was activated. The dashboard user can also type in a specific telephone number to send a test message to ensure the system is working properly. The screen 264 also displays an audit trail so that the dashboard user can view who made the last change, what the change was and when the change took place. From this screen 264, the dashboard user can select a main button to return to the main screen, select an applications button to return to the applications screen 260 or select a log out button to log out of the dashboard.

From the applications screen 264, the dashboard user can select a handset table button to view an application handset table screen 266. The application handset table screen 266 allows the dashboard user to custom load inventories by handset model for each product, so that users will only receive purchase invitations for products that are compatible with the model of handsets or wireless devices they own. This information includes the type of application and the number (types) of handsets or wireless devices the application will support as well as the URL for downloading the application. From this screen 266, the dashboard user can select a main button to return to the main screen, select an application button to return to the application screen 260 or select a log out button to log out of the dashboard.

From the application handset table screen 266, the dashboard user can select an add file button to add a new application. Upon selecting the add file button, an upload application URL screen 268 is displayed. See FIG. 10c. The upload application URL screen 268 allows a new application to be added by first entering the URL where the application can be uploaded from and selecting the handsets that this application will support. Next, the dashboard user can select a main button to return to the main screen, select an application button to return to the application screen 260 or select a log out button to log out of the dashboard.

If the dashboard user selects the sequencing button from the applications screen 60 (See FIG. 10a), an applications sequencing screen 270 is displayed. See FIG. 10c. This screen 270 displays the sequence or priority that the messages are sent to users about purchasing an application will be sent so the dashboard user can increase or decrease the priority of a particular application in the scheduled list. When sending out a purchase invitation, the dashboard automatically sends a message to the user showing the highest priority application available for purchase that has not previously been sent. From this screen 270, the dashboard user can select a main button to return to the main screen, select an applications button to return to the applications screen 260 or select a log out button to log out of the dashboard.

If the dashboard user selects the statistics button from the applications screen 260 (See FIG. 10a), an applications statistics screen 272 is displayed. See FIG. 10d. This screen 272 displays the statistics of the sales of the applications. Specifically, the screen 272 displays a bar graph of the inventory coverage of sales opportunities by month. Additionally, this screen 272 shows the number of available applications, the number or opt-in subscribers and the total sales amount by dollars. From this screen 272, the dashboard user can select a main button to return to the main screen, select an applications button to return to the applications screen 260 or select a log out button to log out of the dashboard.

If the dashboard user selects the opt-in invitation button from the applications screen 260 (See FIG. 10a), an applications opt-in invitation screen 274 is displayed. See FIG. 10d. This screen 274 allows the dashboard user to enter a message or invitation to be sent to users inviting the users to purchase an application. The dashboard user can also type in a specific telephone number to send a test message to ensure the system is working properly. The screen 274 also displays an audit trail so that the dashboard user can view who made the last change and when the change took place. From this screen 274, the dashboard user can select a main button to return to the main screen, select an applications button to return to the applications screen 260 or select a log out button to log out of the dashboard.

If the dashboard user selects the sales message button from the applications screen 260 (See FIG. 10a), an applications sales message screen 276 is displayed. See FIG. 10e. This screen 276 allows the dashboard user to enter a sales message to be sent to users inviting the users to preview the application for purchase. The screen 276 also displays an audit trail so that the dashboard user can view who sent the message and when it was sent. From this screen 276, the dashboard user can select a main button to return to the main screen, select an applications button to return to the applications screen 260 or select a log out button to log out of the dashboard.

FIG. 11a illustrates options the dashboard user can access from the hardware screen 278 of the mobile alerts dashboard. As can be seen from screen 278, the dashboard user can choose between inventory, sequencing, statistics, opt-in invitation, sales message, main or log out. If the dashboard user selects the inventory button, a hardware inventory screen 280 is displayed. See FIG. 11b. The hardware inventory screen 280 displays a list of available hardware for purchase. The list displays the hardware, the status of the hardware, when the hardware will be available for purchase, the age range of the user that would most likely be interested in the hardware, the sex of the user the would most likely be interested in the hardware, the ID of the hardware and how many of each piece of hardware has been sold. From this screen 280, additional hardware can be added or information about the hardware can be exported to an excel spreadsheet. The dashboard user can select a main button to return to the main screen, select a hardware button to return to the hardware screen 278 or select a log out button to log out of the dashboard.

From the hardware inventory screen 280, the dashboard user can select a piece of hardware to view specific details about. As shown in FIG. 11b, upon selecting the specific hardware, a hardware screen 282 is displayed. The hardware screen 282 allows the status of the hardware to be changed, lists type of hardware, the provider, the number (types) of handsets or wireless devices the hardware will support and the number of days left for the user to opt-in. Also listed are the age range for the most likely user and the sex of the most likely user. Furthermore, from this screen 282 the dashboard user can view the date the hardware was activated. The dashboard user can also type in a specific telephone number to send a test message to ensure the system is working properly. The screen 282 also displays an audit trail so that the dashboard user can view who made the last change, what the change was and when the change took place. From this screen 282, the dashboard user can select a main button to return to the main screen, select a hardware button to return to the hardware screen 278 or select a log out button to log out of the dashboard.

From the hardware screen 278, the dashboard user can select a handset table button to view a hardware handset table screen 284. The hardware handset table screen 284 allows the dashboard user to custom load inventories by handset model for each product or hardware, so that users will only receive purchase invitations for hardware that are compatible with the model of handsets or wireless devices they own. This information includes the type of hardware and the number (types) of handsets or wireless devices the hardware will support. From this screen 284, the dashboard user can select a main button to return to the main screen, select a hardware button to return to the hardware screen 278 or select a log out button to log out of the dashboard.

From the hardware handset table screen 284, the dashboard user can select an add file button to add a new piece of hardware. Upon selecting the add file button, a hardware device screen 286 is displayed. See FIG. 11c. The hardware device screen 286 allows a new piece of hardware to be added by indicating the hardware device to add and selecting the handsets that this hardware device will support. Next the dashboard userenters a description of the hardware device that will be sent to a user along with a picture of the hardware device. Upon selecting the new hardware device and saving it, the dashboard user can select a main button to return to the main screen, select hardware button to return to the hardware screen 278 or select a log out button to log out of the dashboard.

If the dashboard user selects the sequencing button from the hardware screen 278 (See FIG. 11a), a hardware sequencing screen 288 is displayed. See FIG. 11d. This screen 288 displays the sequence or priority that the messages are sent to users purchasing hardware devices will be sent, so the dashboard user can increase or decrease the priority of particular hardware device in the scheduled list. When sending out a purchase invitation, the dashboard automatically sends a message to the user showing the highest priority hardware device available for purchase that has not previously been sent. From this screen 288, the dashboard user can select a main button to return to the main screen, select a hardware button to return to the hardware screen 278 or select a log out button to log out of the dashboard.

If the dashboard user selects the statistics button from the hardware screen 278 (See FIG. 11a), a hardware statistics screen 290 is displayed. See FIG. 9d. This screen 290 displays the statistics of the sales of the hardware devices. Specifically, the screen 290 displays a bar graph of the inventory coverage of sales opportunities by month, a bar graph of the purchases vs. the offers by month and a bar graph of the sales by month. Additionally, this screen 290 shows the number of available hardware devices, the number of opt-in subscribers and the total sales amount by dollars. From this screen 290, the dashboard user can select a main button to return to the main screen, select a hardware button to return to the hardware screen 278 or select a log out button to log out of the dashboard.

If the dashboard user selects the opt-in invitation button from the hardware screen 278 (See FIG. 1a), a hardware opt-in invitation screen 292 is displayed. See FIG. 11e. This screen 292 allows the dashboard user to enter a message or invitation to be sent to users inviting the users to purchase a piece of hardware. The dashboard user can also type in a specific telephone number to send a test message to ensure the system is working properly. The screen 292 also displays an audit trail so that the dashboard user can view who made the last change and when the change took place. From this screen 292, the dashboard user can select a main button to return to the main screen, select a hardware button to return to the hardware screen 278 or select a log out button to log out of the dashboard.

If the dashboard user selects the sales message button from the hardware screen 278 (See FIG. 11a), a hardware sales message screen 294 is displayed. See FIG. 11e. This screen 294 allows the dashboard user to enter a sales message to be sent to users inviting the users purchase the hardware device. The screen 294 also displays an audit trail so that the dashboard user can view who sent the message and when it was sent. From this screen 294, the dashboard user can select a main button to return to the main screen, select a hardware button to return to the hardware screen 278 or select a log out button to log out of the dashboard.

FIG. 12a illustrates options the dashboard user can access from the survey screen 296 of the mobile alerts dashboard. As can be seen from screen 296, the dashboard user can choose between surveys, opt-in invitation main or log out. If the dashboard user selects the surveys button, a carrier surveys screen is displayed 298. See FIG. 12a. The carrier surveys screen 298 displays a list of available surveys in the system. The list displays the survey the status of the survey, the type of survey, the ID of the hardware and results of each survey. From this screen 298, additional surveys can be added or the surveys can be exported to an excel spreadsheet. The dashboard user can select a main button to return to the main screen, select a carrier surveys button to return to the surveys screen 296 or select a log out button to log out of the dashboard.

From the carrier surveys screen 298, the dashboard user can select a survey to view specific details about. Upon selecting the specific survey, a specific survey screen 300 is displayed. See FIG. 12b. The specific survey screen 300 allows the survey to be changed, including the questions asked, the responses to the questions and the number of days left for the user to opt-in. Furthermore, from this screen 300, the dashboard user can view the date the survey was activated. The dashboard user can also type in a specific telephone number to send a test message to ensure the system is working properly. The screen 300 also displays an audit trail so that the dashboard user can view who made the last change, what the change was and when the change took place. From this screen 300, the dashboard user can select a main button to return to the main screen, select a survey button to return to the surveys screen 296 or select a log out button to log out of the dashboard.

From the survey screen 300, the dashboard user can select a results button to view a survey results screen 302. The survey results screen 302 shows the results of the survey. As shown in the example in FIG. 10b the satisfaction of users with the available applications or games to purchase is illustrated. This will allow the dashboard user to make decisions as to whether an application should remain available for purchase. The survey results screen also lists the number of respondents and indicates the age range of the respondents and the sex of the respondents. The survey results shown in FIG. 12b are by way of example and various other types and forms of survey results can be displayed. From this screen 302, the dashboard user can select a main button to return to the main screen, select a survey button to return to the survey screen 296 or select a log out button to log out of the dashboard.

If the dashboard user selects the opt-in invitation button from the surveys screen 296 (See FIG. 12a), a survey opt-in invitation screen 304 is displayed. See FIG. 12c. This screen 302 allows the dashboard user to enter a message or invitation to be sent to users inviting the users to participate in a survey. The dashboard user can also type in a specific telephone number to send a test message to ensure the system is working properly. The screen 304 also displays an audit trail so that the dashboard user can view who made the last change and when the change took place. From this screen 292, the dashboard user can select a main button to return to the main screen, select a survey button to return to the survey screen 296 or select a log out button to log out of the dashboard.

FIG. 13a illustrates options the dashboard user can access from the opt-in subscribers screen 306 of the mobile alerts dashboard. As can be seen from screen 306, the dashboard user can choose between subscribers and statistics. If the dashboard user selects the subscribers' button, a subscribers screen 308 is displayed. See FIG. 13b. The subscribers screen 308 displays a list of subscribers in the system. The list displays the telephone number of the subscriber, whether the subscriber has opted-in to receive messages about surveys, ringtones, wallpapers, applications and hardware, the age range and sex of the subscriber, the opt-in date of the subscriber and the number of sales to the subscriber. From this screen 308, the dashboard user can select a main button to return to the main screen, select a subscribers button to return to the opt-in subscribers screen 306 or select a log out button to log out of the dashboard.

From the subscribers screen 308, the carrier, provider, publisher or aggregator can select a subscriber to view additional details about the particular subscriber. Upon selecting a specific subscriber, a subscriber screen 310 is displayed. See FIG. 13b. The subscriber screen 310 shows what purchases the subscriber or user has made. The screen 310 also displays an audit trail so that the dashboard user can view who made the last change and when the change took place. Upon selecting the new hardware device and saving it, the dashboard user can select a main button to return to the main screen, select subscribers button to return to the opt-in subscribers screen 306 or select a log out button to log out of the dashboard.

If the dashboard user selects the statistics button from the opt-in subscribers screen 306 (See FIG. 13a), an opt-in subscribers statistics screen 312 is displayed. See FIG. 13b. This screen 312 displays the statistics of the subscribers. Specifically, the screen 312 shows the total number of opt-in subscribers and displays a pie chart of the number of female and male subscribers and a bar graph of the females and males broken down by month. From this screen 312, the dashboard user can select a main button to return to the main screen, select an opt-in subscribers button to return to the opt-in subscribers screen 306 or select a log out button to log out of the dashboard.

FIG. 14a illustrates options the dashboard user can access from the 3^{rd} party surveys screen 314 of the mobile alerts dashboard. As can be seen from screen 314, the dashboard user can choose between 3^{rd} party surveys and opt-in invitation. If the dashboard user selects the 3^{rd} party surveys' button, a 3^{rd} party surveys screen 316 is displayed. See FIG. 14b. The 3^{rd} party surveys screen 316 displays a list of available 3d party surveys in the system. The list displays the 3^{rd} party survey, the status of the 3^{rd} party survey, the type of 3^{rd} party survey, the ID of the hardware and results of each 3^{rd} party survey. From this screen 316, additional 3^{rd} party surveys can be added or the 3^{rd} party surveys can be exported to an excel spreadsheet. The dashboard user can select a main button to return to the main screen, a 3^{rd} party surveys button to return to the 3^{rd} party surveys screen 314 or select a log out button to log out of the dashboard.

From the 3^{rd} party surveys screen 316, the dashboard user can select a 3^{rd} party survey to view specific details about. Upon selecting the specific 3^{rd} party survey, a specific 3^{rd} party surveys screen 318 is displayed. See FIG. 14b. The specific 3^{rd} party surveys screen 318 allows the 3^{rd} party survey to be changed, including the questions asked and the responses to the questions. Furthermore, from this screen 318, the dashboard user can view the date the 3^{rd} party survey was activated. The dashboard user can also type in a specific telephone number to send a test message to ensure the system is working properly. The screen 318 also displays an audit trail so that the dashboard user can view who made the last change, what the change was and when the change took place. From this screen 318, the dashboard user can select a main button to return to the main screen, a 3^{rd} party surveys button to return to the 3^{rd} party surveys screen 314 or select a log out button to log out of the dashboard.

From the specific 3^{rd} party surveys screen 318, the dashboard user can select a results button to view a 3^{rd} party survey results screen 320. The 3^{rd} party survey results screen 320 shows the results of the 3^{rd} party survey. As shown in the example in FIG. 14c, the results of a particular 3^{rd} party survey are illustrated. The 3^{rd} party survey results screen 320 also lists the number of respondents and indicates the age range of the respondents and the sex of the respondents. The 3^{rd} party survey results shown in FIG. 14c are by way of example and various other types and forms of 3^{rd} party survey results can be displayed. From this screen 320, the dashboard user can select a main button to return to the main screen, select a 3^{rd} party surveys button to return to the 3^{rd} party surveys screen 314 or select a log out button to log out of the dashboard.

If the dashboard user selects the opt-in invitation button from the surveys screen 314 (See FIG. 14a), a 3^{rd} party surveys opt-in invitation screen 322 is displayed. See FIG. 14c. This screen 322 allows the dashboard user to enter a message or invitation to be sent to users inviting the users to participate in a survey. The dashboard user can also type in a specific telephone number to send a test message to ensure the system is working properly. The screen 322 also displays an audit trail so that the dashboard user can view who made the last change and when the change took place. From this screen 322, the dashboard user can select a main button to return to the main screen, select a 3^{rd} party surveys button to return to the 3^{rd} party surveys screen 314 or select a log out button to log out of the dashboard.

FIG. 15a illustrates a method of sending offers and coupons to a user's mobile wireless device. In this method, a user receives an invitation to opt-in, on the screen 324 of a wireless device, to an opportunity or program that sends the user exclusive offers and coupons from merchants. Merchants include, but are not limited to, retailers, restaurants, airlines and the like. From this screen 324, the user can select a set it up button 326 to opt-in to the program or a no thanks button 328 to opt-out. Selecting the no thanks button 328 ends the program. Selecting the set it up button 326 causes a set up screen 330 to be displayed where the user selects alert settings. i.e. the frequency of notification of available coupons to be sent. After selecting the frequency, the user is asked to select the types of coupon of interest 332, such as specific retailers. When the selections are made, the user selects the next button 334 causing additional screens to be pushed to the user's wireless device asking additional questions, such as what the user's age range is 336 and what gender the user is 338. Although not shown, the user may be asked questions, including but not limited to, the user's preference in music, movies, dining and travel. This information creates a preference profile of the user that is saved by the system 340. A confirmation screen is displayed 342 informing the user of a successful opt-in.

The preference profile of the user is utilized by the wireless carrier to send coupons that the user will be most likely interested in. For example, if the user is a 20 to 29 year old female that has indicated an interest in shoe stores, an alert 344 about a coupon for a shoe retailer is sent to the user's wireless device. If the user elects to view the coupon now, a link 346 launches the coupon 348 on the user's wireless device. The user has the option to save the coupon, reject the coupon or edit the user's alert setting. The coupon may contain a barcode which can be scanned by the retailer, using a barcode scanner, for the user to obtain the coupon. Although FIG. 15a illustrates an example of an offer for shoes, this is by way of example only and an offer for any product or service can be purchased using the method of the present invention.

FIG. 15b illustrates a method of viewing saved offers and coupons on a user's mobile wireless device. In this method, a screen 350 is displayed requesting the user select between the options of viewing saved coupons, alert settings, help or exiting the program. If the user selects to view the saved coupons, a list of retailers and the number of coupons for each retailer for which the user has coupons is displayed 352. By selecting a specific retailer, a list of the available coupons from that retailer is displayed 354. By selecting a specific coupon, the coupon is displayed 356. The coupon 356 indicated the expiration date as well as a barcode and/or other decoding element allowing the user to present the coupon to a retailer to redeem. The user can also scroll through the available coupons for that retailer using a previous button 358 and a next button 360, select the no thanks button 362 or edit alerts button 364. The location based services of mobile devices will be utilized to recognize when a user is within a specified distance of an opted-in merchant. Once within this specified distance, an alert with a list of available coupon for that merchant will be sent to the user's wireless device 353.

Although an exemplary embodiment of the invention has been described above by way of example only, it will be understood by those skilled in the field that modifications may be made to the disclosed embodiment without departing from the scope of the invention, which is defined by the appended claims.

1. A method of sending interactive messages to a user's wireless device, the method comprising the steps of:
sending an interactive message to a user's wireless device informing the user of at least one opportunity that the user can participate in;
creating a preference profile of the user if the user decides to participate in the at least one opportunity;
determining an opportunity to send to the user based on the preference profile;
sending the opportunity to the user, where the opportunity includes a coupon for a discount on an item;
displaying the coupon on the screen of the user's wireless device, where the coupon includes a barcode; and
redeeming the coupon by presenting the barcode on the display to a scanner when purchasing the item.

2. The method of claim 1, wherein the preference profile includes the user's age range, gender and preference in merchants.

3. The method of claim 1, wherein the user can select the frequency at which opportunities are sent.

4. The method of claim 1, wherein the at least one opportunity includes receiving offers from merchants on the user's wireless device.

5. The method of claim 4, wherein the merchants are selected from the group consisting of retailers, restaurants, airlines,

6. The method of claim 1, wherein the interactive message is sent to the user using any enabling push technology.

7. The method of claim 4, wherein an alert is sent to the user's wireless device about the coupon.

8. The method of claim 1, wherein the user can save the coupon for later use.

9. The method of claim 4, wherein the user can display available coupons by a specific merchant.
